(19) United States
(12) Patent Application Publication
(10) Pub. No.: US 2011/0065597 A1
(43) Pub. Date: Mar. 17, 2011

(54) SINGLE MOLECULE PROTEOMICS WITH DYNAMIC PROBES

(75) Inventors: John G.K. Williams, Lincoln, NE (US); Lyle Middendorf, Lincoln, NE (US); Jon Anderson, Lincoln, NE (US); David Steffens, Lincoln, NE (US); Harry Osterman, Lincoln, NE (US); Daniel Grone, Lincoln, NE (US)

(73) Assignee: LI-COR, INC., Lincoln, NE (US)

(21) Appl. No.: 12/841,047

(22) Filed: Jul. 21, 2010

Related U.S. Application Data
(63) Continuation of application No. PCT/US2010/021625, filed on Jan. 21, 2010.
(60) Provisional application No. 61/146,544, filed on Jan. 22, 2009.

(51) Int. Cl. C40B 30/04

(52) U.S. Cl. 506/9

(57) ABSTRACT

Methods are disclosed utilizing single-molecule proteomics with dynamic probes to accomplish a variety of protein analytic applications. A panel of probes, when used in combination, can resolve and quantify a proteome in a simple assay detecting transient binding to single protein targets.

### CROSS-REFERENCES TO RELATED APPLICATIONS

This application is a continuation application of PCT/US2010/021625, filed Jan. 21, 2010, which application claims priority to U.S. Provisional Patent Application No. 61/146,544, filed Jan. 22, 2009, the teachings of which are hereby incorporated by reference in their entirety for all purposes.

### BACKGROUND OF THE INVENTION

State-of-the art proteomics technology rests on two foundations, namely mass spectrometry and antibody probes. Mass spectrometry is currently capable of resolving and quantifying up to 6000 proteins in a single run. Large, expensive (US$1 billion) projects are contemplated to 1) identify one protein for each human gene, 2) create one antibody for each protein, and 3) create a comprehensive protein-protein association database (Service, R. F., Science, 321, 1758-1761 (2008)). With projected advances in technology and in protein discovery, new platforms and methodology for quantifying proteins in a high-throughput, highly-multiplexed, low-cost assays are needed to benefit research in cancer and other diseases, including a database of probe interactions for proteins comprising core pathways in cancer progression.

The conventional approach in antibody-based proteomics is “n” target types requiring “n” unique probe types in a “1-protein: 1-antibody” strategy (Bowley, D. R. et al., Proc Natl Acad Sci USA (2009); Slootweg, E. J. et al., Nucleic Acids Res, 34(20), e137 (2006)). Furthermore, in DNA arrays, an excess of probe types, greater than “n” are required to identify “n” target types using mismatched probe/target homology. Although a Tₘ assay can be performed on DNA arrays by altering the temperature and looking for release of binding events, this method cannot be currently performed by the existing art where the number of probe types is less than the number of target types.

Prior art single molecule approaches for analyzing the affinity between binding pairs is limited to low throughput tools, such as atomic force microscopy (AFM) and fluorescence correlation spectroscopy (FCS) (Schmidt, T., Hinterdorfer, P., and Schindler, H., Microsc Res Tech, 44(5), 339-46 (1999); Bieschke, J. et al., Proc Natl Acad Sci USA, 97(10), 5468-73 (2000): Schwesinger, F. et al. Proc Natl Acad Sci USA, 97(18), 9972-7 (2000); Tetin, S. Y., Swift, K. M., and Matayoshi, E. D., Anal Biochem, 307(1), 84-91 (2002)). Both AFM and FCS use point detection where a single binding pair is detected at a given moment of time. In order to really achieve high throughput, many binding pair events need to be measured simultaneously. Taguchi et al. disclose the analysis of the interaction between chaperonin and cochaperonin at the single molecule level (Taguchi et al. Nature Biotechnology Vol 19, 861-865 (2001)). Further, U.S. Pat. No. 6,511,854 to Asanov discloses an electrochemical method of disassociating a binding partner from a corresponding binding partner using a waveguide surface. Other approaches focus on specific binding pair interaction with protein structure/function (Temirov, J. P., Bradbury, A. R., and Werner, J. H., Anal Chem, 80(22), 8642-8 (2008); Pal, P. et al., Biophys J, 89(2), L11-3 (2005); Wayment, J. R. and Harris, J. M., Anal Chem, 81(1), 336-42 (2009)). Sill others include, R. D. Mitra in U.S. Patent Pub. No. 2007/0218503; Analytical Chemistry, 7130-31 (September 2009); and Lee A. Tessler, Jeffrey G. Reifenberger and Robi D. Mitra Anal. Chem., 2009, 81 (17), pp 7141-7148. The conventional approach is to identify intracellular structure by detecting single-molecules with super-resolution.

The prior art is limited in that it does not enable the use of low affinity probes to identify target types in a configuration where there are fewer probe types than targets. There is a need to complement or supplement existing proteomic tools, such as Surface Plasmon Resonance (SPR), 2-D gel electrophoresis, and mass spectrometry (MS), due to the need for enhanced throughput, sensitivity, and specificity. The present invention meets these and other needs.

### BRIEF SUMMARY OF THE INVENTION

New platforms and methodology for quantifying proteins in high-throughput, highly-multiplexed, low-cost assays are needed to benefit research in cancer and other diseases, including a database of probe interactions for proteins comprising cell signaling and metabolic pathways in cancer progression. As such, the present invention provide methods for identifying and characterizing biomolecules such as proteins, as well as detecting binding interactions between binding pair members.

In one embodiment, the present invention provides a method for characterizing at least one protein in a plurality of proteins, comprising:
contacting the plurality of proteins with a panel of probes, wherein at least one probe has a unique label, to generate a transient binding interaction of at least one probe of the panel of probes with at least one protein of the plurality of proteins; and detecting the transient binding interaction by single molecule detection of the unique label to generate a time spectrum, wherein the time spectrum characterizes the at least one protein.

In another embodiment, the present invention provides a method for measuring a transient binding interaction between at least one protein in a plurality of proteins with at least one probe of a panel of probes, comprising:
contacting a plurality of proteins immobilized on a support with a panel of probes, wherein at least one probe has a unique label, for a time sufficient to generate a transient binding interaction of at least one probe of the panel of probes with at least one protein of the plurality of proteins; and
measuring the transient binding interaction by single molecule detection of the unique label to generate a time spectrum, wherein the transient binding interaction is characterized by at least one constant selected from an association rate constant (kₒₙ), an dissociation rate constant (k_{off}) and a combination thereof.

In still yet another embodiment, the present invention provides a method for characterizing at least one biomolecule in a plurality of biomolecules, comprising:
contacting the plurality of biomolecules with a panel of probes, wherein at least one probe has a unique label, to generate a transient binding interaction of at least one probe of the panel of probes with at least one biomolecule of the plurality of biomolecules; and
detecting the transient binding interaction by single molecule detection of the unique label to generate a time spectrum, wherein the time spectrum characterizes the at least one biomolecule.

These and other aspects, objects and embodiments will become more apparent when read with the detailed description and figures that follow.

### BRIEF DESCRIPTION OF THE DRAWINGS

FIGS. 1A-D illustrate one embodiment of a panel of probes interacting transiently with many different proteins immobilized on a surface (A); in one embodiment, transient binding events at the surface are imaged in movies by a fluorescence microscope (B); each time trace is reduced to a “time spectrum,” a histogram of the observed residence times (C); histograms are categorized (D).

FIG. 2 illustrates a weighted distributions of “time spectra” as a function of time.

FIGS. 3A-B illustrate the structure of IRDye 700DX (A); NIH3T3 cells were fixed and permeabilized, followed by incubation with rabbit anti-histone primary antibody and goat anti-rabbit secondary antibody labeled with IRDye 680, IRDye 700DX, or Alexa Fluor 680. Images were recorded (B).

FIGS. 4A-B illustrate one embodiment of calculating a number of probes required to resolve the proteome. A set of two probes (r=2), each with three categories (c=3), thus provides cr=32=9 patterns of affinity, namely 00, 01, 02, 10, 11, 12, 20, 21 and 22 (A). More probes provide exponentially more combinations (B).

FIGS. 5A-B illustrate protein immobilization on a self-assembled monolayer SAM of poly(ethylene glycol) PEG. Panel (A) shows the layer organization and process steps for surface modification; panel (B) shows the chemical structures matched by number to the layers.

FIGS. 6 A-B illustrates protein immobilization on a PEG “polymer brush.” Panel (A) shows the layer organization and process steps for surface modification; panel (B) shows the chemical structures matched by number to the layers.

FIGS. 7 A-B illustrate the zwitterionic surface modification type. Protein lysines can be coupled to surface carboxylates by carbodiimide chemistry (EDC, NHS) (A). The zwitterionic brush is smaller in diameter than the PEG brush (B).

FIGS. 8A-F illustrate ROXS buffer reduces blinking and bleaching of Atto647N. Sample wells formed with a silicon gasket applied to a coverglass coated in streptavidin. A 10 attomolar solution of biotin-Atto647N (Atto-Tec) was placed in a well for about 1 minute, and the well was rinsed with water (A). The well was filled with ROXS buffer containing both an oxidant (methylviologen) and reductant (ascorbic acid) in a deoxygenating cocktail as described. The well was sealed with a coverglass piece and movies were recorded using an Olympus IX-70 inverted microscope. The image stack was background-subtracted using ImageJ software. The stack average of an example fluorescent “particle” is shown in the figure (B). Control sample using the buffer of B without redox components, showing the stack average of another fluorescent particle (C). Time traces of representative particles B and C, showing that ROXS conditions prevent blinking in Atto647N (D). Fluorescent particles were counted in each frame of the image stack B and C in order to quantify photobleaching (E). Exponential fits indicate an extended half-life of 77 sec in ROXS conditions compared to 13 sec in the control, a six-fold improvement (F).

FIGS. 9 A-B. illustrate one million proteins dispersed randomly in the field of view (100×100 um) yields 80% (˜800,000 proteins) at super-resolution spacing≧30 nm to the nearest neighbor. Dots represent proteins resolved from their neighbors, in contrast to unresolved clusters (A). Number of resolved proteins as a function of total proteins on the surface, showing 80% yield at density (B).

FIG. 10 illustrates one embodiment of a plot of time (x axis) plotted against single molecule count (y axis).

FIG. 11 illustrates one embodiment of a plot of β-tubulin concentration (x axis) plotted against single molecule count (y axis).

### DETAILED DESCRIPTION OF THE INVENTION

### I. Definitions

“Biomolecule” as used herein includes any type of biomolecule for which detection (including quantitative detection) may be desired, including but not limited to, peptides, proteins, nucleic acids, sugars, mono- and polysaccharides, lipids, lipoproteins, whole cells, and the like.

“Binding pair” as used herein includes a pair of molecules, one of which can be a probe and the other one can be a target molecule, which members of the pair of molecules can bind to one another with different affinities or not at all. Examples of suitable binding pairs include, but are not limited to, nucleic acid and nucleic acid; protein or peptide and nucleic acid; protein or peptide and protein or peptide; antigens and antibodies; receptors and ligands, haptens, or polysaccharides, complementary nucleic acids, pharmaceutical compounds, and the like.

The term “detect” or “detection” as used herein includes the determination of the existence, presence or fact of a target protein or signal in a limited portion of space, including but not limited to, a sample, a protein, a biomolecule, a binding event, a reaction mixture, a molecular complex and a substrate. A detection refers, relates to, or involves the measurement of quantity, amount or identity of the target protein or signal (also referred as quantitation), which includes but is not limited to, any analysis designed to determine the presence, absence, amounts or proportions of the target or signal. A detection also refers, relates to, or involves identification of a quality or kind of the target protein or signal in terms of relative abundance to another target or signal.

“Protein” or “polypeptide” include a polymer of amino acid residues. These terms also apply to amino acid polymers in which one or more amino acid residues is an artificial chemical analogue of a corresponding naturally occurring amino acid, as well as naturally occurring amino acid polymers. An amino acid polymer in which one or more amino acid residues is an “unnatural” amino acid, not corresponding to any naturally occurring amino acid, is also encompassed by the use of the team “protein” and “polypeptide” herein.

The term “target” or “target molecule” or protein target as used herein includes an analyte of interest. The term “analyte” includes a protein, substance, compound or component whose presence or absence in a sample has to be detected. Analytes include, but are not limited to, biomolecules and in particular proteins, or biomarkers. The term “biomolecule” as used herein indicates a substance compound or component associated to a biological environment including, but not limited to, sugars, amino acids, peptides, proteins, oligonucleotides, polynucleotides, polypeptides, organic molecules, haptens, epitopes, biological cells, parts of biological cells, vitamins, hormones and the like. The term “biomarker” indicates a biomolecule that is associated with a specific state of a biological environment including, but not limited to, a phase of cellular cycle, or health and disease state. The presence, absence, reduction, up regulation or down regulation of the biomarker is associated with and is indicative of a particular state.

The term “probe” as used herein includes a molecule which binds to another molecule (the target) in a binding pair, which probe molecule can be used to determine the presence or absence of the other molecule (i.e., target) The term “probe” is an agent including a binder and a unique label (e.g., a signaling moiety). In some embodiments, the binder and the signaling moiety of the probe are embodied in a single entity (e.g., a fluorescent molecule capable of binding a target). In certain instances, a probe can non-covalently bind to one or more protein targets in the biological sample. In certain instances, a probe can specifically bind to a target. Probes can be any member of a binding pair and include, for example, natural or modified peptides, proteins (e.g., antibodies, affibodies, or aptamers), nucleic acids (e.g., polynucleotides, DNA, or RNA); polysaccharides (e.g., lectins, sugars), lipids, enzymes, enzyme substrates or inhibitors, ligands, receptors, antigens, haptens, or synthetic nucleic acids such as DNA, RNA, small molecules, and the like.

The term “probe type” as used herein includes a descriptor to uniquely categorize a population of probe molecules having identical probe characteristics.

The term “target type” as used herein includes a descriptor to uniquely categorize a population of target molecules having identical target characteristics.

The term “panel of probes” as used herein includes a population of molecules selected from one or more probe types.

### II. Embodiments

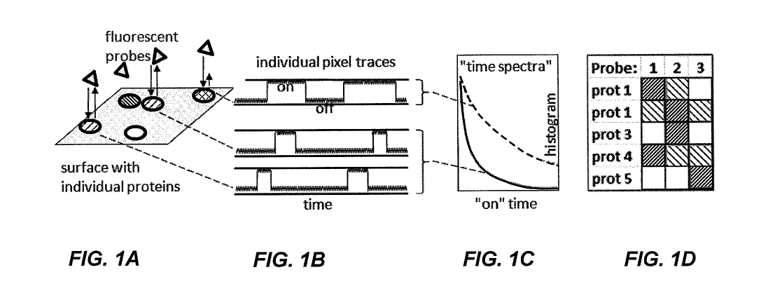

FIG. 1A-D represents a schematic of one embodiment of the present invention. FIG. 1A shows a panel of probes contacting a surface with a plurality of proteins. In certain aspects, probes interact transiently with many different proteins immobilized on a surface, binding some proteins for a long time before unbinding, while binding other proteins for a shorter time period, and still other proteins not at all. Advantageously, the methods herein provide one or more of the following characterizations of a protein such as distinguishing, counting, quantifying, and/or identifying the protein. The methods herein are conveniently described as digital single molecule proteomics (DSMP), which allow the digital measurement of expression such as protein expression.

FIG. 1B shows transient binding events at the surface, which in certain aspects, are imaged in movies by a fluorescence microscope, such as a total internal reflection fluorescence (TIRF) microscope. Time trace data of individual pixels is extracted by image analysis software, revealing that probes reside for longer periods (on) at some spots than at other locations. In certain instances, a suitable probe can be selected depending on the sample of proteins to be analyzed and available for detection. For example, a target protein can include a receptor and the probe can include a ligand. Similarly, a target protein can include an antibody or antibody fragment and a probe can include an antigen. In some embodiments, both the target protein and the probe can include proteins or peptides capable of binding to each other.

In certain preferred aspects, as is shown in FIG. 1C, each time trace can be reduced to a “time spectrum,” or in other words, a histogram of the observed residence times of the binding events (the probe(s) with a target). The longer the duration of binding the flatter the time spectrum represented by the histogram. In certain instances, histograms can then be categorized by, for example, a maximum likelihood estimator (MLE) according to how well the histograms match model histograms of known probe-target interactions. It will be apparent to those of skill in the art that the following equation K_{d}=k_{off}/kₒₙ preferably characterizes transient binding. Although the kₒₙ is one preferred metric of the transient binding of the probe, other transforms and derivatives including K_{d}, k_{off} as well as others are also suitable to generate a histogram and time spectrum. These include manipulations and any proxy of this equation K_{d}=k_{off}/kₒₙ. The observed residence times of the binding events of a probe(s) with a target will be on a time frame of about 1 nanosecond to about 10 minutes, preferably, about 1 nanosecond to about 1 second, and more preferably about 1 millisecond to 1 second such as 20 milliseconds to 1 second.

In one aspect, as is shown in FIG. 1D, three categories of transient binding are indicated, i.e., the molecular affinity between protein and probe (black, gray, white). However, those of skill in the art will recognize that the invention is not so limited. In certain aspects, there are many “affinity categories” for example, at least 1, at least 2, at least 3, at least 4, at least 5, at least 6, at least 7, at least 8 and the like, of molecular affinities between protein and probe. As is shown in FIG. 1D, unique patterns emerge after a sufficient number of probes are tested and ranked. Unexpectedly, a handful of probes resolves large proteomes.

In certain aspects, there are at least 5 categories of affinity. For example, the first category of affinity is 0, wherein there is no detectable binding. The next category is 1, having a K_{d} between protein and probe of about 1 μM to about 999 μM. In the next category of 2, is where the K_{d} between protein and probe is 1 nM to about 999 nM. In the next category of 3, the K_{d} is about 1 μM to about 999 μM. In the last category of 4, the probe binds, but does not unbind in the detection time frame (e.g., <1 μpM or covalent binding).

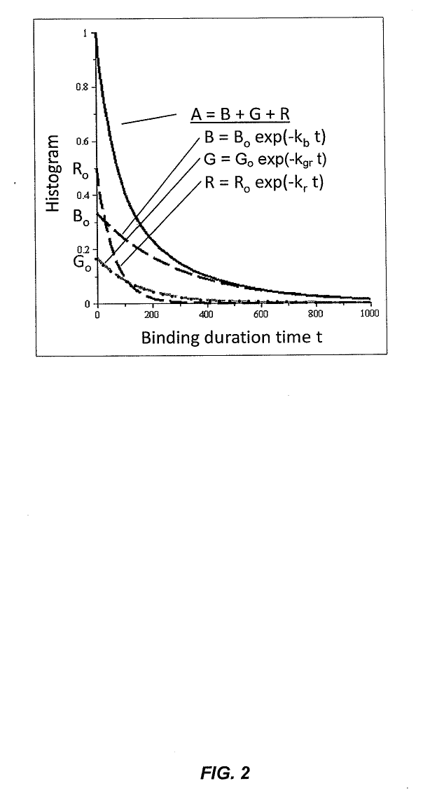

FIG. 2 shows one embodiment of the present invention. As shown therein, in certain instances, time spectra may not be reducible to a single characteristic score, for example an exponential decay constant obtained by curve fitting. In certain instances, simple thermal unbinding results in exponential distributions of probe off-times characterized by decay constants k. In addition, probe affinity can be affected by protein conformation shifts over time, for example among three states differing in decay constants k and relative occurrence (“weight” Bₒ, Gₒ, Rₒ). The observed time spectrum is the weighted sum of the fundamental interactions (A=B+G+R). Some proteins have more than one binding site for a given probe. In certain other instances, weighting each of the conformations and/or binding sites depends on the relative energy of each state (function of pH, ionic and temperature conditions), and the orientation of each individual protein. In certain instances, orientation influences both the conformational energies and the accessibility of probes to binding sites. All such heterogeneity is embodied in the distribution of transient binding times, which can be regarded as “a spectrum” analogous to other types of spectra, for example optical absorbance or fluorescence spectra. Measured spectra can be matched such as pattern matching to standard curves in a database by maximum likelihood estimation methods (Davis, L. M., Shen, G., ed., Proceedings of SPIE, ed. J. A. Conchello, Cogswell, C. J., Wilson, T. Vol. 6443, SPIE Press. 64430N (2007)). In one embodiment, algorithms such as maximum likelihood estimation methods classify time spectra by pattern matching.

In certain instances, the affinity between binding pairs can be assessed using competitive assays (see, Tetin, S. Y., Swift, K. M., and Matayoshi, E. D., Anal Biochem, 307(1), 84-91 (2002)). In certain aspects, either member of a binding pair can be genetically modified to enhance the affinity or detectability of a binding event, such as GFP fusions, two-protein detection schemes, and epitope fusion tagging. In certain preferred aspects, low affinity probes can be multiplexed across several targets, whereby information is determined by a fingerprint or pattern associated with probe/target affinity.

A. Probes

In certain embodiments, a probe is an agent that is capable of binding a target protein. Typically, a probe comprises a signaling moiety such a fluorophore. Probes can be any member of a binding pair and include, for example, natural or modified peptides, proteins (e.g., antibodies, affibodies, nanobodies or aptamers), nucleic acids (e.g., polynucleotides, DNA, or RNA); polysaccharides (e.g., lectins, sugars), lipids, enzymes, enzyme substrates or inhibitors, ligands, receptors, antigens, haptens, or synthetic nucleic acids such as DNA, RNA, small molecules, and the like. The probes can be, for example, organic or inorganic molecules.

In addition, the probes can be formed by synthetic molecules. (Iterative In Situ Click Chemistry Creates Antibody-like Protein-Capture Agents, H. D. Agnew et al., Angew. Chem. Int. Ed. 2009, 48, 4944-4948.) (Accurate MALDI-TOF/TOF Sequencing of One-Bead-One-Compound Peptide Libraries with Application to the Identification of Multiligand Protein Affinity Agents Using in Situ Click Chemistry Screening, Su Seongi Lee et al., Anal. Chem., 2010, 82 (2), pp 672-679.)

In certain aspects, a panel of probes is selected from random libraries of peptides, small ligands, small molecules and the like. In one instance, candidate probe agents can be, peptides, polypeptides, peptidomimetics, amino acids, amino acid analogs, saccharides, fatty acids, steroids, purines, pyrimidines, derivatives or structural analogues thereof, polynucleotides, and polynucleotide analogs. In certain instances, the panel of probes can be homogeneous or heterogeneous. That is, the panel can comprise the same members (homogeneous panel of one probe type) or different probe members (heterogeneous panel selected from more than one probe type). In other words, the panel can be all of one molecular type, or different molecular types.

In certain other instances, the probes are derived from a random library of peptides such as those that are commercially available, or generated using combinatorial techniques well known to those of skill in the art. Preferably, the individual probes in the panel of probes have a spectrum of binding affinities, so within the panel there are weak binding affinities (i.e. a low binding profile for a specific target bound to the surface) and strong binding probes (probes that bind tightly to the target), as well as intermediate binding affinitites. Thus, the probes bind with enough diversity to generate a “signature.”

In most instances, the individual probes will have a unique label associated therewith. In certain preferred instances, a signaling moiety such as a fluorophore is covalently attached. Suitable fluorophores include, but are not limited to, 4-acetamido-4′-isothiocyanatostilbene-2,2′ disulfonic acid; acridine and derivatives: acridine, acridine isothiocyanate; 5-(2′-aminoethyl)aminonaphthalene-1-sulfonic acid (EDANS); 4-amino-N-[3-vinylsulfonyl)phenyl]naphthalimide-3,5 disulfonate; N-(4-anilino-1-naphthyl)maleimide; anthranilamide; BODIPY; Brilliant Yellow; coumarin and derivatives: coumarin, 7-amino-4-methylcoumarin (AMC, Coumarin 120), 7-amino-4-trifluoromethylcouluarin (Coumaran 151); cyanine dyes; cyanosine; 4′,6-diaminidino-2-phenylindole (DAPI); 5′,5″-dibromopyrogallol-sulfonaphthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansylchloride); 4-dimethylaminophenylazophenyl-4′-isothiocyanate (DABITC); eosin and derivatives: eosin, eosin isothiocyanate, erythrosin and derivatives: erythrosin B, erythrosin, isothiocyanate; ethidium; fluorescein and derivatives: 5-carboxyfluorescein (FAM), 5-(4,6-dichlorotriazin-2-yl)aminofluorescein (DTAF), 2′,7′-dimethoxy-4′5′-dichloro-6-carboxyfluorescein (JOE), fluorescein, fluorescein isothiocyanate, QFITC, (XRITC); fluorescamine; IR144; IR1446; Malachite Green isothiocyanate; 4-methylumbelliferoneortho cresolphthalein; nitrotyrosine; pararosaniline; Phenol Red; B-phycoerythrin; o-phthaldialdehyde; pyrene and derivatives: pyrene, pyrene butyrate, succinimidyl 1-pyrene; butyrate quantum dots; Reactive Red 4 (Cibacron™ Brilliant Red 3B-A) rhodamine and derivatives: 6-carboxy-X-rhodamine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of sulforhodamine 101 (Texas Red); N,N,N′,N′-tetramethyl-6-carboxyrhodamine (TAMRA); tetramethyl rhodamine; tetramethyl rhodamine isothiocyanate (TRITC); riboflavin; rosolic acid; terbium chelate derivatives; Cy 3; Cy 5; Cy 5.5; Cy 7; IRD 700; IRD 800; La Jolla Blue; phthalo cyanine; naphthalo cyanine ATT0647; and IRDye 680LT.

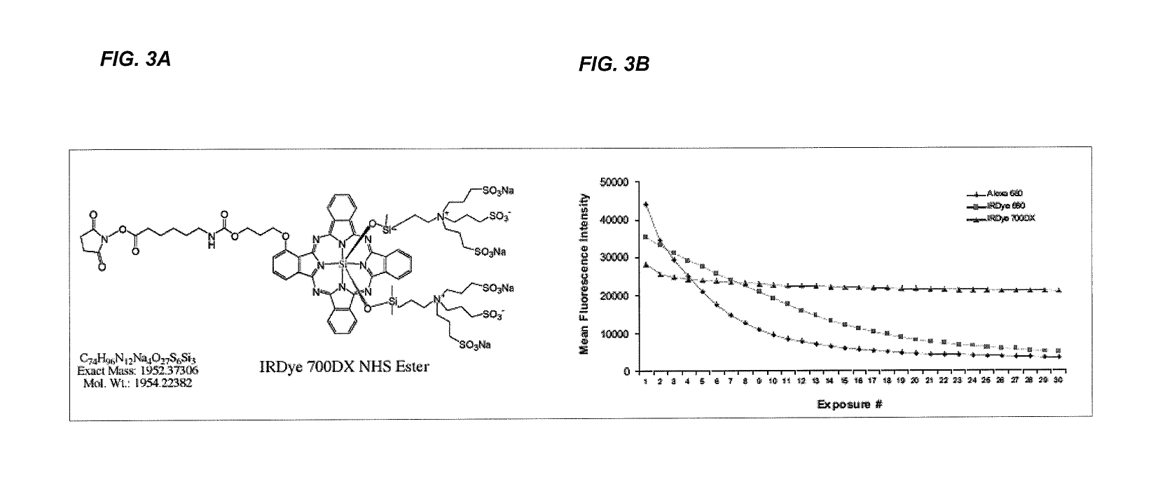

In other instances, other fluorophores are suitable for use. These include, for example, green fluorophores (for example Cy3, FITC, and Oregon Green), which can be characterized by their emission at wavelengths generally in the range of 515-540 nanometers, and red fluorophores (for example Texas Red, Cy5, and tetramethylrhodamine), which can be characterized by their emission at wavelengths generally in the range of 590-690 nanometers. In one preferred aspect, a highly-photostable silicon-phthalocyanine dye IRDye, 700DX (see, FIG. 3A), which is notable not only for its photostability (FIG. 3B), but also for its high water-solubility and protein-phobic (non-stick) properties, can also be imaged with high sensitivity (SNR=15), and superior photostability.

In certain aspects, the invention provides for the use of labels to identify co-localization. For example, in order to specifically identify phosphorylation of a protein, a tight binding probe containing one fluorophore (probe 1) can be used in combination with a phosphorylation specific probe containing a second fluorophore (probe 2). Co-localization of the two probes identifies phosphorylation of the specific protein. Additionally, the percent of phosphorylation is determined by the ratio of probe 2 to probe 1.

In one aspect, probe selection criteria can be used to select the proper probe. These criteria include, for example, whether a candidate probe interacts too strongly with the bare assay surface. Further criteria is whether a candidate probe interacts with only a few proteins, or whether a candidate probe interacts with proteins on time scales too short for sampling by the optical system, or too long for recording multiple events in a predetermined period. In certain aspects, the probes are structurally diverse. Examples of diversity in peptide interactions include phage display where the selected peptides often have affinities too low for practical purposes (Choi, S. J. et al., Mol Cells, 7(5), 575-81 (1997)), and in work screening biotin peptide mimics by methodically varying a peptide sequence at two amino acids (Schmidt, T. G. et al., J Mol Biol, 255(5), 753-66 (1996)).

In certain instances, a panel of probes are selected from a small finite number of probe types. For example, the number of probe types is represented by a panel of probes, which is at most 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or at most 50 probe types.

In other instances, a panel of probes is selected from at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or at least 50 probe types. In certain instance, there are about 1 to about 15 probes or 2 to 10 probe types in the panel of probes imaged simultaneously. In fact, any number of probe types in the panel of probes can be imaged simultaneously.

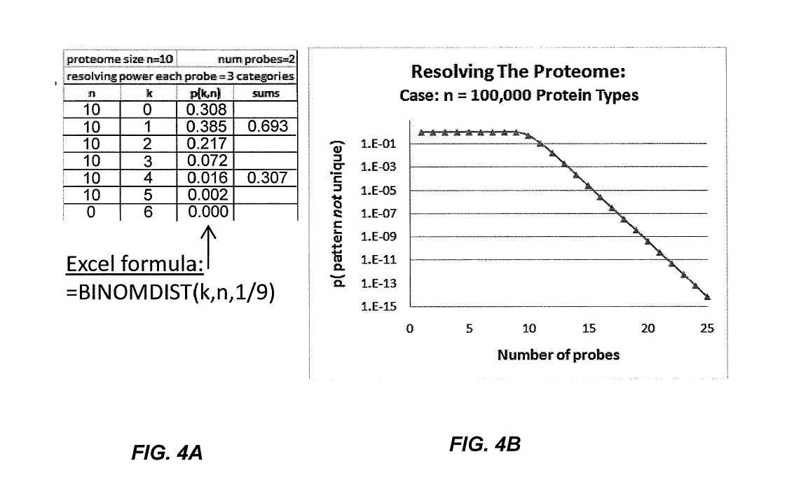

In one embodiment, the number of probe types to resolve a proteome is calculated as follows. Each interacting protein-probe pair is detected in a train of transient interactions from which a distribution of transient binding times (a histogram, a “time spectrum”) (FIG. 1C) is obtained. The time spectrum embodies the integrated binding affinity between a probe and protein over conformational states and orientations (FIG. 2). A set of time spectra produced by a corresponding set of probe types is a fingerprint, or pattern of probe affinities, for a given protein. In order to determine how many probe types are required to fully resolve a proteome by associating a unique fingerprint with each protein, in a preferred embodiment, each time spectrum is classified into at least three categories of affinity (low, med, high); judicious choice of thresholds (e.g., K_{d}) assures adequate representation for each category. Applying the binomial distribution (FIG. 4B), a proteome of 100,000 protein types is resolved by unique patterns of affinity measured with a minimum of 21 probe types; that is, the probability of a given fingerprint occurring in two different protein types is negligible (4.57E⁻¹¹).

Looked at in another way (FIG. 4), one would have to fully type 4.3 different species for one chance of encountering a non-unique pattern. With six categories (instead of three), proteome resolution would require a minimum of 13 probe types (instead of 21). Maximum-likelihood pattern matching algorithms that allow digitizing into more than three categories require fewer probe types. As such, using the methods herein, a small panel of informative probe types is sufficient to fully resolve any proteome.

In one operational embodiment, proteins from a sample are randomly immobilized on a surface at resolvable surface densities of up to 800,000 protein molecules per 100×100 μm field. A panel of fluorescent probes is applied, and the surface is imaged using a total internal reflection fluorescence (TIRF) microscope to record movies of individual probes binding transiently with individual immobilized proteins. For each tested probe type, a characteristic distribution of transient times, a “time spectrum,” is obtained from the traces of transient interactions recorded at each protein location. The time spectrum embodies the integrated affinity of the probe for the target protein. A set of probes is used to generate a corresponding set of time spectra that together comprise a unique fingerprint of the protein. Low probe concentrations minimize fluorescence background from unbound probes while still promoting reasonable binding rates at the surface. Low probe affinities imply rapid unbinding. The system can thus record multiple on-off (transient) events in order to estimate the distribution of transient times in reasonable assay time. Low probe specificities (promiscuous probes) mean that each probe can interact with many different proteins, thus empowering a small set of probes to query the full proteome. Large proteomes are resolved with just a small number of low-specificity, low-affinity, partially orthogonal probes used in combination to define unique fingerprints for each protein.

In certain embodiments, after the time spectra from a first probe type within the panel of probes are recorded, the substrate is contacted with a second probe type within the panel of probes. This sequential experiment allows for identification with more granularity as the information from the first probe type within the panel is used to identify the characteristics of at least one protein with this probe type. The sequential experiment can be repeated multiple times in an iterative fashion, with each iterative probe type obtaining additional data. To establish an unequivocal identification, in certain aspects, an antibody can be used as the final probe type. In certain aspects, in order to achieve high throughput, the methods detect many binding pair events simultaneously.

For example, in the first panel of probe types (a homogeneous panel), the panel contains a small peptide (a 5-mer), wherein each 5-mer is labeled with the same fluorophore. The 5-mers are identical. The first panel of probe types is followed with a second homogeneous panel of probe types, which panel contains a pyrimidine derivative (a small molecule) which is labeled. Finally, in a third panel of probe types (a homogeneous panel), wherein the panel contains an antibody specific for phosphorylated proteins. Again, the antibodies are labeled.

Although the current invention preferably provides for a “normal” arrangement wherein proteins are bound to a surface and are detected with probes that are labeled, it also embodies a “reverse” arrangement wherein probes are bound to the surface and detected with one or more labeled proteins.

In certain aspects, specific target proteins are identified biologically by their interaction patterns matching known profiles in a database of interaction patterns. Additionally, interaction patterns can be used to identify associations between unknown targets and sample populations defined by infectious disease, phenotypic characteristics, development, and differentiation. Protein types, whether known or unknown to the database, are thereafter quantified by direct counting of single immobilized proteins. Protein standards are used to both monitor system performance and characterize immobilization bias. In certain instances, samples require prior fractionation in order to detect rare proteins in large backgrounds of dominant proteins (e.g. serum albumin), depending on the relative scarcity of the target proteins. Informative sets of dynamic probes are selected in advance by screening peptide, protein, or small-molecule probe libraries.

In certain instances the probe of the panel of probes is a peptide such as an RGD peptide (arginine-glycine-aspartic acid), which is specific for an integrin. In other instances, the at least one probe type of the panel of probes is a small molecule, an aptamer or an antibody.

In certain embodiments, probes within the panel of probes are present at concentrations at about 1M to about 0.001 nM or even 1 pM, preferably about 1 mM to about 100 mM, more preferably at about 1 μM to about 100 μM and most preferably, 0.1 nM to about 5 nM such as 0.1, 0.2, 0.3, 0.4, 0.5, 0.6, 0.7, 0.8. 0.9, 1, 2, 3, 4, or 5 nM.

In certain instances, the number of probes in the panel of probe types is less than the number of protein types in the plurality of proteins. The transient binding interaction of the at least one probe to the at least one protein is categorized “c” as a low affinity (O), medium affinity (1) or high affinity (2) and the number of probe types is (r) and the patterns of affinity is c^{r}. In one example, there are 3 probe types and 5 categories 5³=525 patterns. In certain instances, the probe has low-affinity and low-specificity.

In certain embodiments, it is possible to automate the delivery of probes to the substrate. High throughput robotic armature in laboratories is routine. Automation of panels of probes as well as samples is within ordinary skill in the art. (see, Parallel microfluidic surface plasmon resonance imaging arrays Eric Ouellet et al., Lab Chip, 2010.

Just as time spectra are used to characterize probe interactions with proteins immobilized on a surface, time spectra can also be used to characterize probe interactions with the bare surface itself. In many instances, this utilization of time spectra allows probe-surface “background” interactions to be eliminated from the data set in software algorithms. In practice, probe-surface time spectra are obtained in control experiments with the bare surface devoid of immobilized target protein. This allows one means for background subtraction. Those of skill in the art will recognize other uses for such data.

B. Samples

A sample can be any composition containing a biomolecule target. Preferably, the biomolecule target is a protein or a plurality of proteins. These proteins include, but are not limited to, polypeptides, peptides, glycoprotein, lipoproteins, microbial polypeptides (e.g., viral, bacterial, or protozoan polypeptides), antibodies, enzymes, disease markers (such as polypeptide cancer antigens), cell surface receptors, hormone receptors, cytokines, chemokines, tissue specific antigens, or fragments of any of the foregoing.

The samples include cell lysates, tissues, tumors, enzymes, biopsy samples, yeasts, fungus, bacteria, plant cells, mammalian cells, circulating tumor cells, biological warfare or terror agents and the like. The content of the sample can be known, characterized and identified, or unknown, uncharacterized and unidentified. In many cases, a sample contains or is suspected of containing one or more enzymatic activities. In other aspects, the sample can be soil remediation sample. A sample can be derived from an organism or can be a man-made. A sample can be, e.g., one containing one or more enzymes in a known quantity or with a known activity. The sample is not a template nucleic acid when the probe is a labeled nucleotide for use in nucleic acid sequencing.

In certain aspects, a biological sample includes tissue sections of normal (colon, lung, etc.) tissue, which can be compared to tissue sections of cancerous (colon, lung, etc.) tissue. Other normal tissues include breast tissue, prostate tissue, kidney tissue, skin, lymph nodes and the like, and can be compared to cancerous tissues of the same tissue type.

C. Protein Immobilization

In certain aspects, the substrate or solid support includes any solid or semi-solid material in which a target binding agent such as a plurality of proteins can be attached or incorporated (e.g., physical entrapment, adsorption, and the like) or which can be functionalized to include (e.g., to associate with) a target. Suitable materials include, but are not limited to, a natural or synthetic polymer, resin, metal, or silicate. The proteins can be immobilized in a random fashion or in ordered arrays.

In certain preferred aspects, the present invention provides for a variety of different surfaces (e.g. glass, quartz, plastic) or trapping configurations for immobilizing target molecules for single molecule detection in order to observe probe/target binding kinetics. Suitable chemistries can be used to generate a nonstick surface capable of attaching the target molecules for single molecule detection. The invention provides for detectable probes or detectable targets, such that detection occurs at the single molecule level in order to maximize the determination of kinetic information, in order to acquire “on” and “off” rate constants. Whereas the preferred embodiment immobilizes target molecules such as proteins on a surface, the methods also provide target molecules in solution. The affinity between binding partners can be externally modulated to optimize the affinity information. External modulation can be accomplished by, electric fields, magnetic fields, energy fields, pressure fields, a wash step, convective flow, temperature changes, pH changes, ionic composition or strength changes, and the like.

In one embodiment, the present invention provides a durable surface for target protein immobilization, capable of withstanding multiple wash cycles. In this aspect, the bare surface interacts negligibly with a fluorescent probe, which in turn minimizes background fluorescence and thus “false positive” signals. In certain aspects, a blocking buffer can be used, which is preferably devoid of protein contaminants. In certain preferred aspects, the surface is a thin film (e.g. <30 nm), which keeps proteins nearer the surface for maximal optical excitation; and minimally porous films presenting a flat, compact surface in order to prevent small probes diffusing into the film. In certain aspects, the substrate surface has low binding capacity, which allows for better single-molecule resolution. Certain surface modification is described in US Patent Pub. No. 2009/0175765 to Harris et al. and incorporated herein by reference.

In certain other instances, it is possible to eliminate false positives by subtracting time spectra of the background. This background subtracting is effective in eliminated false positive and increasing the S/N. This procedure also is beneficial to the limit of detection.

In some embodiments, suitable solid-phase support materials include an agarose; a cellulose; a dextran; a polyacrylamide; a polystyrene; a polyethylene glycol; a resin; a silicate; divinylbenzene; methacrylate; polymethacrylate; glass; ceramics; paper; metals; polyacryloylmorpholide; polyamide; poly(tetrafluoroethylene); polyethylene; polypropylene; poly(4-methylbutene); poly(ethylene terephthalate); rayon; nylon; poly(vinyl butyrate); polyvinylidene difluoride (PVDF); silicones; polyformaldehyde; cellulose acetate; nitrocellulose, or a combination thereof. Preferably, the material or combination of materials in the solid support do not interfere with the binding between the probe and the target molecule.

In one embodiment, immobilized carboxylate groups on an amine-reactive surface can be used to covalently link proteins (e.g., with amide bonds) to the substrate via an amine-coupling reaction. Other exemplary reactive linking groups, e.g., hydrazines, hydroxylamines, thiols, carboxylic acids, epoxides, trialkoxysilanes, dialkoxysilanes, and chlorosilanes may be attached to the substrate, such that proteins can form chemical bonds with those linking groups to immobilize them on the substrate.

In certain aspects, the plurality of proteins is immobilized at one or more lysine amines. In general, protein structures typically contain surface-exposed lysine residues, which are thus available for immobilization chemistry. Proteins not containing lysine are still available to be immobilized via amine chemistry if their amino-terminus is surface-exposed. Alternative immobilization chemistries, such as utilizing the acid side chains of aspartate and glutamate, can also be used.

Various concentrations of proteins can be detected and measured by the methods described herein. Proteins present at concentrations less than, e.g., 100 milligrams/milliliter (mg/ml), 10 mg/ml, 1 mg/ml, 100 micrograms/milliliter (μg/ml), 10 μg/ml, 1 μg/ml, 100 nanograms/milliliter (ng/ml), 10 ng/ml, 1 ng/ml, 100 picograms/milliliter (pg/ml), 10 pg/ml, 1 pg/ml, 100 femtograms/milliliter (fg/ml), 10 fg/ml, or 1 fg/ml are detected in the biological sample, and the concentration can be measured. In fact, in a preferred aspect, a single protein molecule is detected and characterized using the methods of the present invention.

In certain aspects, the protein can be immobilized on a surface using methods such as a hydrophilic self-assembled monolayer approach, a hydrophilic polymer brush approach, a zwiterionic polymer brush approach and a nitrile coating approach. In one aspect, the plurality of proteins are randomly immobilized at a surface density of about 2 proteins to about 1.0×10⁶ proteins per 100 μm×100 μm. In another aspect, the plurality of proteins are randomly immobilized at a surface density of about 2.0×10² proteins to about 8.0×10⁵ proteins per 100 μm×100 μm. In still another aspect, the plurality of proteins are randomly immobilized at a surface density of about 2.0×10³ proteins to about 6.0×10⁴ proteins per 100 μm×100 μm. In still yet another aspect, the plurality of proteins are randomly immobilized at a surface density of about 2.0×10³ proteins to about 1.0×10⁴ proteins per 100 μm×100 μm.

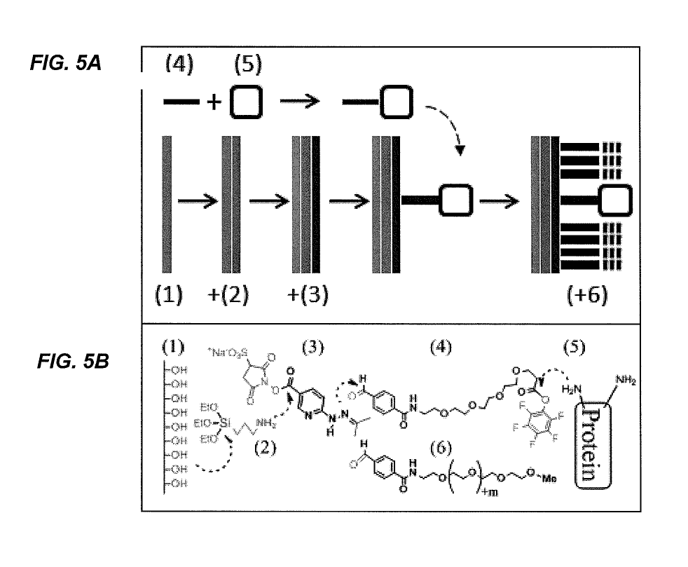

FIG. 5 illustrates one embodiment for protein immobilization using a hydrophilic self-assembled monolayer. As shown therein, proteins are attached to a substrate prior to, or simultaneously with, surface passivation. In this aspect, one suitable linker is commercially available from SoluLinK. Target proteins can be conjugated to a heterobifunctional PEG linker (e.g., PEG-4) conferring a benzaldehyde functionality. The substrate such as glass is activated with for example, hydrazone functional groups. Thereafter, proteins are attached to the surface at low occupancy rates (<0.8 area %) through highly specific, efficient reactions between protein benzaldehyde and surface hydrazone functionalities. Protein occupancy is controlled by protein solution concentration and reaction time and unoccupied surface regions are thereafter passivated with monofunctional (benzaldehyde) PEG chains via the same coupling chemistry used in protein immobilization.

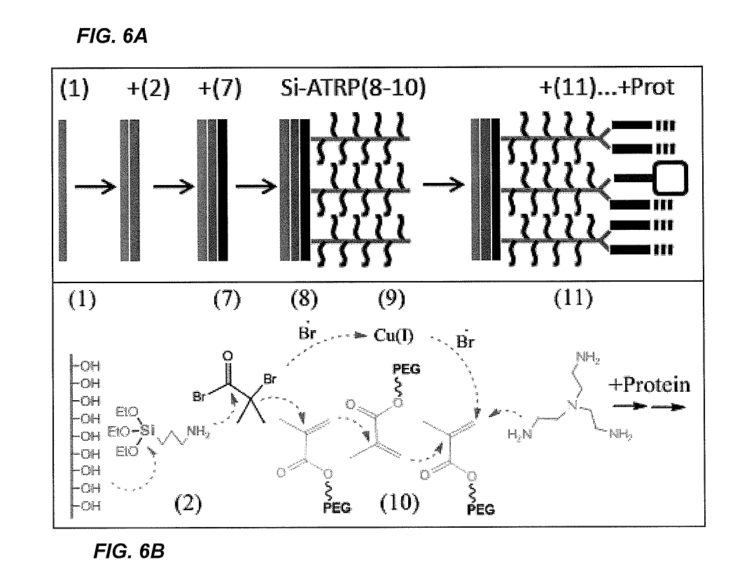

FIG. 6 illustrates another embodiment for protein immobilization using a hydrophilic polymer brush. In this embodiment, a surface is prepared that includes a hydrophilic base layer supporting target proteins. In certain aspects, an effective surface film is the polymer “brush,” synthesized directly on the surface from monomers. A suitable chemistry includes “Si-ATRP” (surface initiated atom transfer polymerization), yielding surface-attached polymers of narrow size distribution from aqueous alcohol solutions. Methyl methacrylate derivatives forming polyacrylic acid brushes can be used. A large selection of methacrylate monomers are available commercially (e.g. Sigma-Aldrich) and are suitable. Alternative monomers include, for example, designer peptide surfaces designed for low protein adsorption (Chelmowski, R. et al., J Am Chem Soc, 130(45), 14952-3 (2008)). Published Si-ATRP protocols (Yao, Y. et al., Colloids and Surfaces B: Biointerfaces, 66, 233-239 (2008); Jones, D. M., Huck, W. T. S., Advanced Materials, 13(16), 1256-1259 (2001); Tugulu, S. et al., Biomacromolecules, 6(3), 1602-7 (2005); Edmondson, S. et al., Chem Soc Rev, 33(1), 14-22 (2004); Ma, H. et al., Langmuir, 22(8), 3751-6 (2006); Vaisocherova, H. et al., Anal Chem, 80(20), 7894-901 (2008)) are followed utilizing PEG methacrylate monomers while targeting film thicknesses in the range 20-50 nm. In certain aspects, the hydrophilic brush layer is derivatized with an amine for protein coupling following a published procedure (Yao, Y. et al., Colloids and Surfaces B: Biointerfaces, 66, 233-239 (2008)), optionally followed by a final passivation.

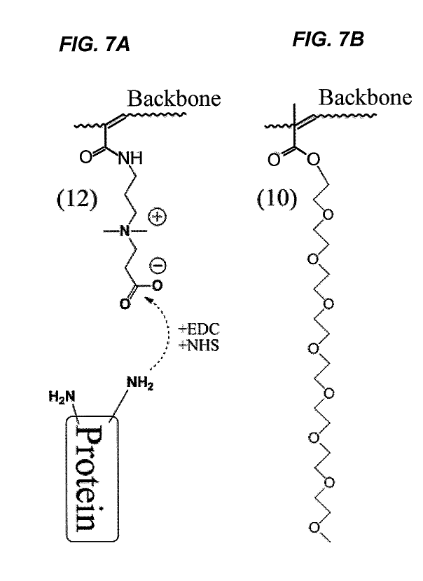

FIG. 7A illustrates yet another embodiment for protein immobilization using a zwitterionic polymer brush suitable for use in the present invention. In certain aspects, a useful zwitterionic polymer brush has low non-specific protein adsorption of serum proteins (see, Vaisocherova and coworkers (Vaisocherova, H. et al., Anal Chem, 80(20), 7894-901 (2008)). As reported therein, the brush thickness was reproducibly thin at 15-20 nm, which locates interacting probes in the peak energy zone of the TIR optical field. In certain approaches, methods are used that directly link lysines of target proteins to surface carboxylates (Vaisocherova, H. et al., Anal Chem, 80(20), 7894-901 (2008)).

In still yet another embodiment, nitrile coating can be used to immobilize a plurality of proteins. A simple cyanoethyl silane coating on glass (Wayment, J. R., Harris, J. M., Analytical Chemistry, 2009) has low background adsorption of neutravidin using single-molecule detection and can be used.

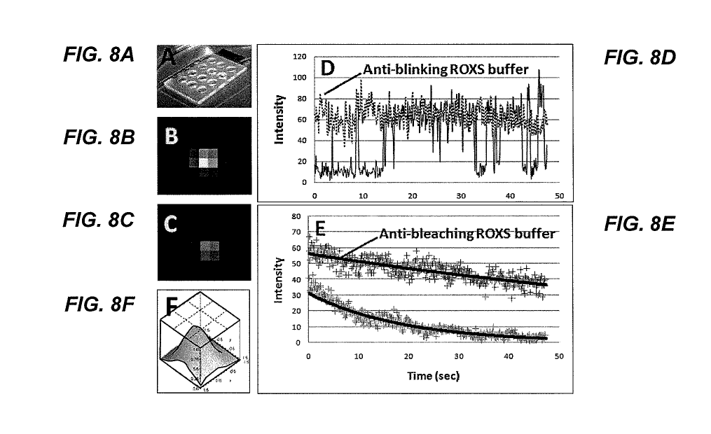

Proteins immobilized on surfaces remain attached during the analysis. While the preferred embodiment uses chemistries directed toward covalent attachment, adsorbed (non-covalent) proteins are also acceptable. To assess immobilization, surface-attached streptavidin is tagged by exposure to biotin-tagged probes “a0” or “x0” (Table 1, Example 5). The protein surface density is adjusted to ensure that at least 90% of probes are bound to protein (i.e. at least 10-fold higher than the background binding to bare surface). After rinsing to remove unbound probes, the surface is imaged in 3 min intervals for several hours in order to estimate the half-life of attached probes. In a complementary method, one immobilizes streptavidin covalently pre-labeled with dye; this eliminates concerns in the alternative method about biotin dissociating from immobilized protein. The effect of dye photobleaching is accounted for statistically by determining the photobleaching rate as before (FIG. 8E).

The methods of the invention described herein provide proteins (or probes) immobilized on a substrate. The probe can include any substance capable of binding or interacting with a protein. Proteins can bind covalently, non-covalently or not at all to the probe. The probe can be a tumor probe (e.g., PSA) that specifically binds to a protein (e.g., anti-PSA protein). Other tumor-associated proteins that can be immobilized on the surface include, e.g., tyrosinase, MUC1, p53, CEA, pmel/gp100, ErbB-2, MAGE-A1, NY-ESO-1, and TRP-2.

Various proteins, modifications and amino acids are detectable using the present invention. These include, for example, phosphorylation modifications, glycosylation, ubiquitinization, methylation, N-acetylation, lipidation, proteolytic processing, a GPI anchor, a disulfide linkage, a pyroglutamic acid, a nitrotyrosine an acylated amino acid, a hydroxyproline or a sulfated amino acid. A phosphorylated amino acid can be, for example, a phosphoserine, a phosphotyrosine, or a phosphothreonine. These can be detected using either high or low specificity probes of high or low affinity.

Other modification and protein “epitopes” are well known to those of skill in the art, or can be identified using well known methods. Advances in the design of epitope-discovery systems have significantly accelerated the epitope discovery process, giving results quickly. Advanced systems, such as ProImmune's (www.proimmune.com) REVEAL™ and ProVE™, produce results faster than could be expected with traditional methods. In certain instances, the probes bind protein structure and conformation. For example, certain probes identify and characterize β-sheets, α-helixes and other conformations that are characteristic of proteins. Using the methods herein, it is possible to perform “epitope” mapping of proteins.

D. Detection

Detection of binding of a panel of probes to a target protein or polypeptide comprises detection of a label attached directly or indirectly to at least one probe. In certain preferred instances, binding (or absence of binding) between a probe and a protein or a polypeptide to be identified can be detected using single molecule detection methods.

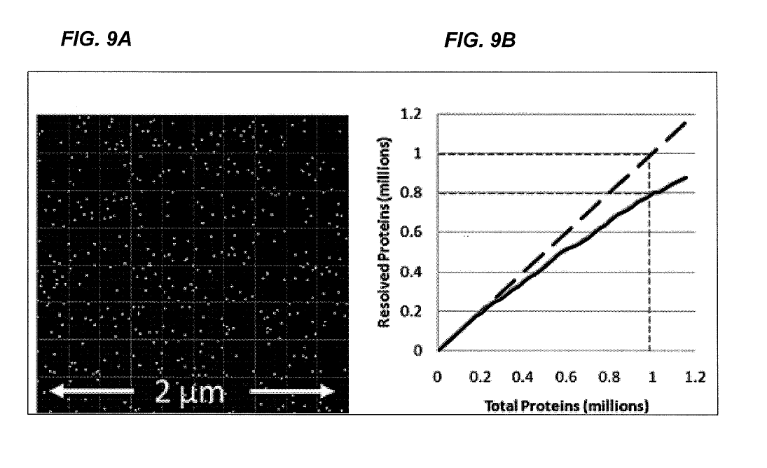

The preferred embodiment utilizes single-molecule imaging methods that provide effective resolution 10-fold, to 20-30 nm (Betzig, E. et al., Science, 313(5793), 1642-5 (2006); Folling, J. et al., Nat Methods, 5(11), 943-5 (2008); Hess, S. T., Girirajan, T. P., and Mason, M. D., Biophys J, 91(11), 4258-72 (2006); Huang, B. et al., Science, 319(5864), 810-3 (2008); Lord, S. J. et al., J Am Chem Soc, 130(29), 9204-5 (2008)). Super-resolution was the TECHNOLOGY OF THE YEAR for 2008 (Hell, S. W., Nat Methods, 6(1), 24-32 (2009); Lippincott-Schwartz, J. and Manley, S., Nat Methods, 6(1), 21-3 (2009)). Other single molecule detection methods are reviewed in Fuller et al., Nature Biotechnology volume 27 number 11 Nov. 2009. These methods rely on various means to randomly switch on fluorescence in a sparse subset of fluorophores populating densely-packed fields. Thus, only a few well-spaced individual molecules are detected in any one image. Subpixel locations are calculated by fitting each imaged diffraction pattern to the theoretical point spread function (FIG. 8F). Accuracy is typically 20-30 nm, set by the Heisenberg limit Δ/¢m where Δ is the width of the diffraction maximum, and m is the number of detected photons (Folling, J. et al., Nat Methods, 5(11), 943-5 (2008)). Different fluorophore subsets are detected in subsequent images, a composition of which reveals the densely-packed field with super-resolution thus the size of a typical protein (10 nm). The invention provides a natural compatibility with super-resolution imaging because only a subset of proteins are detected in any given image. Fluorophore switching is not necessary. The field is naturally parsed both spatially and temporally by probes binding only a subset of the proteins and by probes binding neighboring proteins at different moments in time with on-rates dependent on probe concentration. Diffraction patterns, obtained by summing repeated binding events in movies, are detected with high photon counts m, which supports locating proteins with high accuracy (Δ/¢m). In a preferred embodiment of about 30 nm spatial resolution, one million proteins are immobilized with 80% resolution, rendering 800,000 proteins for analysis (FIG. 9).

The maximum packing density, defined herein where 80% of proteins are resolvable, occurs with just 7900 total proteins yielding 6300 optically resolved proteins in the field of view (FIG. 9).

Total internal reflectance fluorescence (TIRF) microscopy is a preferred detection device of the present invention. TIRF provides an optical effect that can be used to observe fluorescent events occurring at the interface between two optical media of different refractive indices. Excitation laser induced light incident upon such a boundary, travelling at an angle greater than the critical angle, undergoes total reflection. The total internal reflected light extends into the sample on the substrate beyond the interface, extending only a few hundred nanometers into the second medium of lower refractive index (e.g., the z direction). This evanescent field allows for fluorescence excitation. The excitation volume of a TIRF evanescence field extends about 100 nm into the sample. Photons that are created within that excitation volume from the unique labels of the probes, are detected. TIRF microscopy (TIRFM) is used for capturing a high resolution, high signal to noise (S/N) series of binding events as claimed herein. The single molecule detection has spatial resolution at about 1 nm to about 100 nm, preferably about 5 nm to about 50 nm and more preferably at about 10 nm to about 40 nm.

Single molecule detection (SMD) allows for a high degree of multiplexing (e.g. 1 million per 100×100 micron field of view using super-resolution computational imaging). Further, SMD enables counting individual binding pairs and correlating the counts to biological relevance as well as kinetic “on” and “off” rates measured on many individual molecules simultaneously, allowing the assessment of N different types of targets with <N unique probes. Moreover, SMD allows kinetics to be measured without the limitations of equilibrium averages characteristic of ensemble based assays. A variety of detection modalities can be used, including fluorescence, FRET, multi-photon, polarization, plasmonic effects, AFM, force spectroscopy, fluorescence lifetime, light scattering, Raman scattering, and the like.

In a preferred embodiment, the methods provide minimization of background binding of probes to the bare working surface by utilizing protein immobilization surface chemistries that provide a non-stick film supporting the covalent attachment of target proteins. The preferred embodiment of the invention also provides reproducibility in measurements of transient interactions. The background flux of transient binding events are preferably limited to less than 0.05 um⁻² s⁻¹. The background flux of static binding events are preferably less than 0.0005 um⁻² s⁻¹. The protein immobilized half-life is typically greater than 5 hours. The target proteins are reproducibly distinguished with at least 99% confidence by transient binding.

Binding kinetics. Kinetic measurement is the basis of the preferred embodiment. On-rates, off-rates and calculated binding equilibrium constants are obtained by default when fingerprinting immobilized proteins. As such, the preferred embodiment provides an alternative to surface plasmon resonance SPR methods that characterize binding between a purified immobilized protein and a label-free probe.

In certain instances, transient binding interactions are characterized by mathematical transformations of the rate constants, such as autocorrelation histograms, without directly computing the rate constants themselves. In certain instances, proteins of unknown identity, but exhibiting characteristic time spectra with a panel of probes, are identified by probing them with antibodies against known proteins. This facilitates correlating characteristic time spectra with known proteins to populate the database.

E. Library of Time Spectra

In certain embodiments, the methods herein include populating a database with known time spectra. In certain instances, well known and well characterized proteins are interrogated with a panel of probes in order to detect, measure and record transient binding interactions. In certain instances, the proteins are highly purified. In certain instances, the transient binding interactions are characterized by at least one constant selected from an association rate constant (kₒₙ), a dissociation rate constant (k_{off}) and a combination thereof.

After a databases is populated with known time spectra it is possible to use learning statistical classifier systems to identify unknown proteins. For example, it is possible to use training data sets of “time spectra,” i.e., binding interaction for known protein types and modifications. Thereafter, “unknown time spectra” can readily be determined. These systems include, but are not limited to, those using inductive learning (e.g., decision/classification trees such as random forests, classification and regression trees (C&RT), boosted trees, and the like), Probably Approximately Correct (PAC) learning, connectionist learning (e.g., neural networks (NN), artificial neural networks (ANN), neuro fuzzy networks (NFN), network structures, perceptrons such as multi-layer perceptrons, multi-layer feed-forward networks, applications of neural networks, Bayesian learning in belief networks, and the like), reinforcement learning (e.g., passive learning in a known environment such as nave learning, adaptive dynamic learning, and temporal difference learning, passive learning in an unknown environment, active learning in an unknown environment, learning action-value functions, applications of reinforcement learning.), and genetic algorithms and evolutionary programming.

Neural networks are interconnected groups of artificial neurons that use a mathematical or computational model for information processing based on a connectionist approach to computation. Typically, neural networks are adaptive systems that change their structure based on external or internal information that flows through the network. Specific examples of neural networks include feed-forward neural networks such as perceptrons, single-layer perceptrons, multi-layer perceptrons, backpropagation networks, ADALINE networks, MADALINE networks, Learnmatrix networks, radial basis function (RBF) networks, and self-organizing maps or Kohonen self-organizing networks; recurrent neural networks such as simple recurrent networks and Hopfield networks; stochastic neural networks such as Boltzmann machines; modular neural networks such as committee of machines and associative neural networks; and other types of networks such as instantaneously trained neural networks, spiking neural networks, dynamic neural networks, and cascading neural networks.

### III. Applications and Uses of the Methods

Dynamic probing can be complemented by high-affinity specific probes (e.g. antibodies, phosphate chelators) to detect proteome phosphorylation states or to confirm specific target identities. Further applications include proteome-wide protein association studies, biomarker discovery by comparing anonymous proteins between samples, and the purification of unknown biomarkers by chromatographic fractionation of complex samples. The method is also used to compare samples in any species or even environmental samples in absence of specific knowledge.

Phosphorylation state. Protein phosphorylation is an important regulatory mechanism in biochemical networks. Phosphoproteins are commonly purified by metal affinity chromatography, which exploits the strong affinity of phosphate groups for Ga³⁺ immobilized by a chelating ligand (Novotna, L. et al., J Sep Sci, 31(10), 1662-8 (2008)). A fluorescent-tagged Ga³⁺ chelate that binds specifically to phosphopeptides or similar high-affinity probes are used to enumerate immobilized phosphorylated proteins, preferably at the end of a run after the proteins of interest have been identified. The ratio of phosphorylated to unphosphorylated proteins is an indication of the activation state of each identified protein type.

In addition to phosphorylation modifications, the invention detects other modifications such as glycosylation, ubiquitinization, methylation, N-acetylation, lipidation, and proteolytic processing, using either high or low specificity probes of high or low affinity. In addition to protein analysis, the invention detects other binding pairs, i.e. lipids, nucleic acids, inorganic molecules, drugs, environmental molecules (e.g., explosives, toxins).

Protein associations. Specific labeled proteins used as probes against the immobilized proteome reveal both high and low affinity interactions. Protein binding partners unknown to the fingerprint database are purified by standard chromatographic methods, where enriched fractions are assayed using the invention.

Protein purification. The invention also has utility not only in “forward” mode, where probes are used to quantify known immobilized proteins, but also in “reverse” mode where unknown, but interesting, target proteins are subsequently purified in order to determine their biological identity.

Biomarkers in disease. The invention allows case and control samples to be compared to identify immobilized proteins correlated with the disease state. These biomarker proteins are then subsequently purified in order to determine their biological identity.

Biomarkers in the environment. Environmental samples which are collected over time are assayed by the invention to monitor variation in marine, terrestrial, and soil environments. It is possible to correlate proteins with changing ecosystem compositions.

In certain embodiments, the methods described herein are used to evaluate the efficacy of treatment of a disease of a subject. Such an evaluation includes, e.g., obtaining at least one biological sample from the subject typically before treatment begins, as well as obtaining at least one biological sample from the subject any time after commencement of the treatment or therapy. The pre- and post-treatment samples are then evaluated using the methods to characterize at least one protein or probe that is indicative of the disease. The efficacy or success of treatment is evaluated by comparing the amount, or change in protein or probe in each sample. For example, a decrease in the amount of the protein in the sample obtained after treatment commenced is an indication that the treatment or therapy of the disease is efficacious. The presence of proteins (e.g., antibodies) produced in a subject during treatment of a disease is determined using the methods described herein, e.g., to determine the onset or extent of resistance to treatment.

In other aspects, the methods provide a means to evaluate the affinity and/or avidity of a probe to transiently bind to a protein or biomolecule in a biological sample. The affinity and/or avidity of the binding between the binding pair can be used to diagnose disease or to determine the stage of the disease or the length of the disease. The affinity/avidity between a binding pair can change (e.g., increase) in a person as a function of time. This rate of change is also an embodiment of the present invention.

In certain embodiments, the affinity and/or avidity of a probe for a protein is determined by contacting a panel of probes with immobilized proteins on a substrate in a pattern capable of generating a signal such that the probes bind to the protein. Binding of the probe to the protein is then detected based on the signal generated to determine the presence or absence of the protein. The substrate can then be washed with a solution, and the signal is evaluated to determine a change in the amount of bound probe to determine the affinity and/or avidity of the probe-protein binding pair.

### IV. Examples

### Example 1 Illustrates Various Methods to Immobilize Proteins

### A. Protein Immobilization on a Self-Assembled Monolayer

FIG. 5A-B illustrates protein immobilization on a self-assembled monolayer SAM of poly(ethylene glycol) PEG. Panel (A) shows the layer organization and process steps for surface modification; panel (B) shows the chemical structures matched by number to the layers in (A); dashed arrows indicate bonds formed in the coupling reactions without implying mechanism; leaving groups are colored gray. Conditions for processing (1) and (2) are given in (Yao, Y. et al., Colloids and Surfaces B: Biointerfaces, 66, 233-239 (2008)) with reagents from Sigma-Aldrich; the remaining procedures and reagents are from SoluLinK (www.solulink.com). Briefly, a glass coverslip (1) is cleaned and oxidized in “Piranha” solution or oxygen plasma, followed by coating with aminopropyl triethoxysilane (2). The oxidized glass is derivatized with aminopropyl triethoxysilane (2), which is further modified to hydrozone functionality with “Sulfo-S-HyNic” (3). Separately, the protein sample (5) is derivatized to benzaldehyde functionality by reaction of lysine amino acids with linker “PEG4/4FB” (4). Reactant stoichiometry is adjusted to obtain low molar substitution ratios, about 1 linker per 10 proteins, in order to minimize the fraction of proteins having multiple linkers; the substitution ratio is conveniently assessed by colorimetric reaction with “2-Hydrazinopyridine dihydrochloride” (SoluLinK). The activated protein is then coupled to the surface at low occupancy (e.g. <0.8% coverage) in at neutral pH and room temperature. Protein occupancy rates, being controlled by solution protein concentration and reaction time, is assessed by single-molecule microscopy with tight-binding probes (e.g. streptag for streptavidin). Finally, the unreacted surface is passivated with a choice of PEG chain lengths (indicated by banded blue lines: the monodisperse polymers “4FB/PEG4-OMe,” “4FB/PEG12-OMe,” “4FB/PEG24-OMe,” and the long-chain polydisperse “4FB/PEG5000-OMe”). Optionally, the protein and passivating PEGs are coupled simultaneously at optimal mixing ratios to achieve desired surface qualities. The substrate such as glass is activated with for example, hydrazone functional groups. Thereafter, proteins are attached to the surface at low occupancy rates (<0.8 area %) through highly specific, efficient reaction between protein benzaldehyde and surface hydrazone functionalities. A selection of passivating PEG chain lengths are available from SoluLinK (4 to about 114 ethylene glycol monomers, 1.5 to about 40 nm extended chain length); each is tested separately or in various mixing ratios to optimize the surface. Optionally, the last two steps (protein immobilization, surface passivation) is conducted simultaneously, instead of sequentially, in order to reduce the potential for partial protein denaturation by surface adsorption.

### B. Protein Immobilization on PEG “Polymer Brush.”

A PEG “polymer brush.” is illustrated in FIG. 6 A-B. This construction differs from A above in having a thicker layer of PEG, a “polymer brush” that underlies the target proteins. The brush is prepared by surface induced atom transfer radical polymerization (Si-ATRP). Conditions for processing (1) and (2) are as in A above. Si-ATRP involving (7) through (10) proceeds from either alcohol or aqueous/alcohol solutions (Yao, Y. et al., Colloids and Surfaces B: Biointerfaces, 66, 233-239 (2008); Jones, D. M., Huck, W. T. S., Advanced Materials, 13(16), 1256-1259 (2001); Tugulu, S. et al., Biomacromolecules, 6(3), 1602-7 (2005)). Reaction with the terminal amine (11) is according to (Yao, Y. et al., Colloids and Surfaces B: Biointerfaces, 66, 233-239 (2008)). Protein coupling and final surface passivation are as in A above. All reagents are available from Sigma-Aldrich or SoluLinK. The full structure of monomer (10) is shown in FIG. 7B. Si-ATRP is catalyzed by copper complex (9) which abstracts a Br radical (8), leaving a carbon radical on (7). PEG-acrylate (10) polymerizes from the surface as the radical transfers in cycles to the terminal acrylate on the growing chain. Polymerization is temporarily arrested if Br is restored to the terminal acrylate, and resumes when Br is again removed. Polymerization is terminated by addition of the tris-amine (11).

### C. Protein Immobilization on Zwitterionic “Polymer Brush”

A zwitterionic polymer brush is illustrated in FIG. 7A. For example, Vaisocherova et al. (Vaisocherova, H. et al., Anal Chem, 80(20), 7894-901 (2008)) grafted polymer brushes of the zwitterionic methacrylate (12) onto an amine-modified gold surface by Si-ATRP (FIG. 7A). Protein lysines were coupled to surface carboxylates by carbodiimide chemistry (EDC, NHS). Monomer (12) is prepared in 81% yield by reacting N-[3-(dimethylamino) propyl]acrylamide (TCI America) with β-propiolactone (Sigma-Aldrich) in acetone; the white product is washed in ether, dried, and used without further purification. These methods are adapted to amine-modified coverglass. The zwitterionic brush (12) is smaller in diameter than the PEG brush (10) of FIG. 7B. The PEG monomer is available from Sigma-Aldrich.

### Example 2 Illustrates One Method to Calculate the Number of Probe Types Needed

FIG. 4 A-B illustrates one method of calculating the number of probe types required to resolve a proteome. In this example, the time spectra of interacting protein˜probe pairs are digitized to three (c=3) categories of affinity: low (0), medium (1) and high (2). Digitizing is accomplished by maximum likelihood matching to three canonical standard spectra chosen to populate the three categories equally. A set of two probe types (r=2) thus provides c^{r}=3²=9 patterns of affinity, namely 00, 01, 02, 10, 11, 12, 20, 21 and 22. Assuming a completely stochastic, unbiased system, the probability of a given target protein type showing a particular pattern (e.g. “00”) is p=1/cr=1/3²=1/9; and for 3 probes, p=1/27; and so on (FIG. 4A). More probes provide exponentially more combinations.

Assume a model small proteome of n=10 protein types and use the binomial distribution to calculate probabilities of “k successes in n trials.” With two probe types (p=1/9) and 10 protein types (n=10), the probability that a given probe pattern occurs zero times (k=0) or once (k=1) is 0.693; the probability of there being multiple occurrences (k>1) is 1−0.693=0.307. This last figure, 0.307, indicates with high probability (30.7%) that a given pattern is not unique, that 10 protein types probably would not be resolved using just two probe types.

Applying the same logic to an expanded model proteome of n=100,000 protein types, we find that a set of just 21 probe types resolves the proteome (FIG. 4B). With 21 probe types, there is very small probability (4.57E⁻¹¹) that any given pattern is not unique. Comparing all 1E05 protein types in a diagonal matrix (½×1E05×1E05=5E09 comparisons), the expected number of non-unique patterns would be 5E09×4.57E-11=0.23; that is, one non-unique pattern is expected to occur after analyzing 1/0.23=4.3 different proteomes (species).

One million proteins dispersed randomly in the field of view (100×100 um) yields 80% (˜800,000 proteins) at super-resolution spacing≧30 nm to the nearest neighbor is shown in FIG. 9 A-B. Proteins are resolved from their neighbors, in contrast to unresolved clusters. Surface coverage is calculated at just 0.8 area % assuming an average protein diameter of 10 nm. Number of resolved proteins as a function of total proteins on the surface, showing 80% yield at density of 1 million proteins in the 100×100 um field of view (FIG. 9B). 7900 proteins (6300 resolved) are immobilized at the normal 300 nm resolution limit. Simulation: a stochastic computer model (LabVIEW) places proteins on a surface by drawing random (x,y) pairs from a uniform distribution. In each program step, the latest arrival is checked for distance to its nearest neighbors to generate the data shown. Input parameters are the average protein diameter (10 nm) and the super-resolution limit (30 nm).

### Example 3 Illustrates Imaging Using IRDye 700DX

LI-COR IRDye 700DX is shown in FIG. 3A which has multiple charged groups. NIH3T3 cells were fixed and permeabilized, followed by incubation with rabbit anti-histone primary antibody and goat anti-rabbit secondary antibody labeled with IRDye 680, IRDye 700DX, or Alexa Fluor 680. Images were recorded in movies of 2-second exposures by a Roper Micromax CCD in a Zeiss Axiovert S100 microscope. The mean fluorescence intensity of the field is plotted against exposure number (FIG. 3B).

### Example 4 Illustrates Imaging of Atto647N Molecules

Atto647N molecules in ROXS buffer were imaged and in a control buffer without the redox agents (FIG. 8). As already reported by Vogelsang, we observed greatly reduced blinking (FIG. 8D), noting that about two-thirds of molecules emitted steadily during the 50 sec observation, while others still displayed some blinking. Photostability improved about 6-fold, increasing the bleaching half-life to 77 seconds, but did not improve to the same extent (800-fold) reported by Vogelsang (Vogelsang, J. et al., Angew Chem Int Ed Engl, 47(29), 5465-9 (2008)). The improved photostability and complete absence of blinking in a majority of Atto647N molecules enables unambiguous tests.

As is shown in FIG. 8, ROXS buffer reduces blinking and bleaching of Atto647N. (A) Sample wells formed with a silicon gasket (Grace Biolabs) applied to a coverglass coated in streptavidin (Fu, Y. and Lakowicz, J. R., J Phys Chem B, 110(45), 22557-62 (2006)). A 10 attomolar solution of biotin-Atto647N (Atto-Tec) was placed in a well for about 1 minute, and the well was rinsed with water. (B) The well was filled with ROXS buffer containing both an oxidant (methylviologen) and reductant (ascorbic acid) in a deoxygenating cocktail as described (Vogelsang, J. et al., Angew Chem Int Ed Engl, 47(29), 5465-9 (2008)). The well was sealed with a coverglass piece and movies were recorded using an Olympus IX-70 inverted microscope fitted with the Olympus TIRF illumination accessory (excitation laser 638.5 nm, 1.8 mW at the objective Olympus 60x 1.45 NA, Roper Cascade-512 EMCCD camera with maximum amplification, pixel dimension about 200 nm, 100 ms exposure +20 ms readout per frame, 395 frames). The image stack was background-subtracted. The stack average of an example fluorescent “particle” is shown in the figure. (C) Control sample using the buffer of B without redox components, showing the stack average of another fluorescent particle. (D) Time traces of representative particles B and C, showing that ROXS conditions prevent blinking in Atto647N. (E) Fluorescent particles were counted in each frame of the movies B and C in order to quantify photobleaching. Exponential fits indicate an extended half-life of 77 sec in ROXS conditions compared to 13 sec in the control, a six-fold improvement. (F) Super-resolution imaging. Theoretical point spread function shows the diffraction pattern of the fluorescence distributed over a 3×3 pixel grid. The sub-pixel location of a single fluorophore can be calculated by fitting the theoretical function to the observed intensity pattern (see Background section). The surface was plotted from the Airy pattern approximation I(r)≈Iₒ exp(−r²/2w²), Iₒ=peak intensity, r=radius from peak, m≈0.42λf/D, λ=wavelength, f=focal length, D=pupil diameter (wikipedia.org, Airy disk).

### Example 5 Illustrates Background Flux and a Table of Probes

To assay background flux, experiments using some of the probes of Table 1 are performed. Surfaces are prepared as described above, but without protein. Probes (10 uL, 100 μM) are added to chambers (FIG. 8), the chambers are sealed, and surface activity is imaged in movies recorded on a TIRF microscope. The movies are assessed for both transient and static background fluxes using custom software (LabVIEW Vision). Dyes (e.g., Atto647N vs 700DX) are ranked in preference according to their stickiness and on their signal-to-noise in single-molecule images. Conditions of pH, ionic composition, temperature and inclusion of non-ionic detergents (Triton, Tween) are optimized statistically by experimental design methods (Goupy, J., Creighton, L., Introduction to Design of Experiments with JMP Examples, Cary, N. C.: SAS Institute (2007)). The identified best conditions and dye label are used.

TABLE 1
Labeled Probes.

| | | SEQ | | | SEQ. |
|---|---|---|---|---|---|
| PROBE | Atto647N Dye | ID NO: | PROBE | 700DX Dye | ID. NO. |
| a0 | biotin-Atto647N | | x0 | biotin-700DX | |
| a1 | Atto647N- | 1 | x1 | 700DX-sAWRHPQFGG | 13 |
| | sAWRHPQFGG | | | | |
| a2 | sAWRHPQFGG- | 2 | x2 | SAWRHPQFGG-700DX | 14 |
| | Atto647N | | | | |
| a3 | Atto647N-Sarhpqfg | 3 | x3 | 700Dx-sAWRHPQFG | 15 |
| a4 | Atto647N- | 4 | x4 | 700DX-sAWRHPAFGG | 16 |
| | sAWRHPAFGG | | | | |
| a5 | Atto647N- | 5 | x5 | 700DX-SAWRSPAFGG | 17 |
| | sAWRSPAFGG | | | | |
| a6 | Atto647N- | 6 | x6 | 700DX-sAWDSPAFG_{—} | 18 |
| | sAWDSPAFG | | | | |
| a7 | HWWWPASggrr- | 7 | x7 | HWWWPASggrr-700DX | 19 |
| | Atto647N | | | | |
| a8 | HRWWPASggrr- | 8 | x8 | HRWWPASggrr-700DX | 20 |
| | Atto647N | | | | |
| a9 | HRWHPASggrr- | 9 | x9 | HRWHPASggrr-700DX | 21 |
| | Atto647N | | | | |
| a10 | HRWHPDSggrr- | 10 | x10 | HRWHPDSggrr-700Dx | 22 |
| | Atto647N | | | | |
| a11 | VRIPVWHgggs- | 11 | x11 | VRIPVWWHgggs-700DX | 23 |
| | Atto647N | | | | |
| a12 | VEIPVSHgggs-Atto647N | 12 | x12 | VEIPVSHgggs-700DX | 24 |

Table 1. Canonical sequences in all-black text bind streptavidin strongly (a1 “Strep-tag I”) or hen egg white lysozyme strongly (a7) or weakly (a11) (Schmidt, T. G. et al., JMol Biol, 255(5), 753-66 (1996); Vutukuru, S. et al, Langmuir, 24(13), 6768-73 (2008); Yu, H., Dong, X.-Y., Sun, Y, Biochemical Engineering Journal, 18, 169-175 (2004)). Mutations that weaken binding significantly based on general information from these three references are in bold. Probes x0-12 are the same as a0-a12 except they are labeled with a different fluorescent dye.

Reproducibility in measuring transient interactions.

Probe-protein interactions is characterized on the best surfaces using the preferred dye label. The probes listed in Table 1 may be tested, but additional probes may also be tested as necessary to discover probes interacting on a time scale (20-1000 ms) compatible with the imaging system.

Reproducibly Distinguish at Least Two Targets with 99% Confidence by Transient Binding

As an assessment, surfaces prepared with streptavidin or lysozyme are challenged with each probe and the surface are imaged in movies as before. Image analysis software is used to extract both static and transient binding events. The time spectra of individual protein molecules are inspected, analyzed and compared for reproducibility. Buffer conditions optimized can be varied further if necessary to better understand the sensitivity of time spectra to physical conditions. Various mixing ratios of streptavidin and lysozyme are immobilized and the surface assayed with the informative probes identified above. The number of immobilized streptavidin and lysozyme proteins are counted and compared to the mixing ratio used in the immobilization reaction in order reveal any bias in immobilization.

Prepare and characterize dense random arrays approaching the theoretical maximum of one million proteins per 100×100 um field. A set of informative probes is developed by testing candidates against complex protein samples comprising either synthetic mixtures or cell lysates. Both peptide probes and small molecule probes conjugated to fluorophores are tested. Useful probes are identified by an ability to bind transiently (low affinity) to a broad selection of target proteins (low specificity), yielding a differentiated set of reproducible time spectra. A database of probe interactions for proteins of interest is populated for identifying and counting individual proteins in the immobilized proteome. The time spectra of purified proteins, or defined pools comprising different proteins, are measured and entered into the database of protein interactions. The database is further expanded by cataloguing hundreds of both known and unknown proteins eluted in pools from the isoelectric fractionation step of well-characterized 2D gels, or previously identified by mass spectroscopy or in antibody-based assays.

Probe concentration requirement <1 nM. Probe concentrations are high enough to drive frequent binding (one event per protein every few sec), but not so high that background fluorescence prevents detecting bound probes. A probe concentration of 1 nM corresponds to a Poisson-limited signal-to-noise ratio of SNR=18

Note 1: .Calculate the maximum allowed probe concentration:
Penetration depth d=130 nm:
TIRF optics illuminates the surface in an evanescent optical field that decays exponentially from its maximum at the surface (z=0). The penetration depth d is the distance z where the field energy has decayed to 1/e of maximum.

d=(lambda/4Pi)/sqrt(n1̂2*sin ̂2(theta)−n2̂2)=130 nm
where
lambda=650 nm, incident wavelength of the excitation light
n1=1.518, refractive index of the coverglass
n2=1.35, refractive index of the water phase at the coverglass
theta=68 degrees, the angle of incidence at the coverglass-water interface
Pixel volume pixVol=5.2e-18 L:
In our optical setup, each imaged pixel is about 200 nm on edge.
   With penetration depth d=130 nm, pixel volume is
   pixVol=200×200×130=5.2e−18 liters
Mean background fluorescence meanBkg=0.01 at high SNR=18:
Minimum SNR is typically taken as 3. For this calculation we are much more stringent, requiring SNR=18.

SNR=signal/noise=18
where
signal=1 (unit signal is defined for a bound probe)
noise=stdev of the fluctuating background fluorescence
noise=sqrt(variance)=sqrt(meanBkg) in the Poisson limit where variance=mean
SNR=18=signal/noise=1/sqrt(meanBkg)
meanBkg=0.0031 (i.e. number molecules per pixVol)
Maximum allowed free probe concentration C=1 nM:

C=molec/pixVol=meanBkg/pixVol=0.0031/5.2e-18=6.0e14(molec/L)

C=6.0e14(molec/L)/6e23(molec/mole)=1.0 nM,

which is much higher (better) than the SNR=3 typically cited as the limit of detection. For reference, recent work from Wayment and Harris (Wayment, J. R., Harris, J. M., Analytical Chemistry, 2009) allows estimating the binding rate supported at 1 nM probe concentration. They measured binding and unbinding kinetics between sparse, single molecules of biotin on a surface with picomolar concentrations of neutravidin in solution (the opposite of the preferred embodiment), reporting a diffusion-limited binding rate of 1.9E08 (M⁻¹ s⁻¹) at each individual immobilized biotin molecule. Since the probes of our invention are smaller (peptides, kDa) than neutravidin (60 kDa), and since diffusion (of spheres) scales as the inverse square root of molecular weight, this enables a 5.5-fold faster binding rate, 1E09 (M⁻¹ s⁻¹)=5.5×1.9E08 (M⁻¹ s⁻¹), for small probes binding immobilized proteins. Thus, in the preferred embodiment, 1 nM probe produces about 1 binding event per second (1E09 M⁻¹ s^{-1×1}E-09 M=1 s⁻¹) at each immobilized protein. The actual on-rate constants depends on access of probes to protein binding sites and on the binding probability per collision. If rebinding of successive probes is too fast, successive binding event may not be resolvable in the fluorescence time history data. In this case, the binding rate could be reduced using lower probe concentrations <1 nM.

### Example 6

### This Example Shows the Binding Kinetics of Labeled Anti-Tubulin Antibody Probe to Immobilized Tubulin

a) Surface Preparation

The coverglass surface was coated with a hydrophobic silane to facilitate protein immobilization by adsorption. The coverglass piece (No. 1½, 24×40 mm, Corning) was cleaned by sonication (Bransonic Ultrasonic Cleaner, Branson Ultrasonics) for 5 min in 15 mL of ethanol in a plastic tube (HS 15986, Heathrow Scientific), followed by 5 min in 15 mL of Milli-Q water (Millipore). Working in a chemical fume hood, the coverglass was placed in a 50 mm diameter Pyrex petri dish containing 10 mL of Nano-Strip (Cyantek). The dish was placed on a covered hotplate (Echo Therm model, Torrey Pines Scientific) and was heated at 99 C for 1 hr. Working in a clean hood (Purifier Clean Bench, LabConco), the coverglass was rinsed in a stream of water, dried in a stream of nitrogen, and placed in an oxygen plasma (0.35 millibar O2) at full RF power for 5 min (Basic Plasma Cleaner, Harrick Plasma). The coverglass was immediately coated with a hydrophobic silane as follows. The cleaned coverglass was placed in a jar (#02-911,761, 16 oz, PTFE screw-top lid, Fisher Scientific) heated to 50° C. by a heating mantle (600 mL size, Glas-Col) regulated by a PID controller (Hitachi). The lid of the jar was outfitted with three ports: an inlet valve, an outlet valve, and a septum. Utilizing the inlet and outlet valves, the jar was flushed for 5 min with a stream (1 L/min) of nitrogen at 12% relative humidity (calculated for 50° C.) conditioned by a LI-COR Model 610 Dew Point Generator), so that the gas emerging from the jar is the same RH % as the input gas. Both the inlet and outlet valves in the jar lid were then closed, and 40 uL of n-octadecyltrichlorosilane (#S106640.0, Gelest) was injected by syringe through the septum into a well (a lid cut from a 1.5 mL polypropylene microcentrifuge tube) mounted about 1 cm beneath the septum inside the jar. The jar was maintained at 50 C for 1 hr. The coverglass was removed from the jar, placed in a 90 mm Pyrex petri dish, and baked at 120 C for 90 min. The coverglass was stored in the same petri dish at room temperature, and was used for experiments within a week. Just prior to use, an adhesive silicone gasket was bonded to the coverglass to form a 3×4 array of sample wells 4 mm in diameter and 2 mm deep (#4428T, Grace Bio-Labs).

b) Protein Immobilization

Proteins were immobilized in the sample wells by adsorption, followed by surface passivation with a blocking buffer. The surface density of the target protein (tublin) was controlled by adsorbing from solutions of different tubulin concentrations mixed in a fixed BSA concentration. Bovine brain tubulin (1 mg, # TL238, Millipore, Cytoskeleton Inc) was dissolved in a final volume of 185 uL of PBS (phosphate-buffered saline) to a final concentration of 5e-05 M, and was further diluted serially to 4e-08 M, 8e-09 M, 1.6e-09 M, and 6.4e-11 M in a diluent comprising 1e-04 M BSA plus 1e-13 M Qdot-705 nanocrystals (Invitrogen) in PBS. The Qdots adsorb sparsely onto the surface, and provide fluorescent targets for pre-focusing (Probe Binding Reaction, below). BSA stock solutions were prepared by dissolving 3 g of BSA (bovine serum albumin, # A7906-50G, Sigma-Aldrich) in PBS, mixing gently by rotation for 2 hr at room temperature, filtering the solution through a 0.45 micron Millipore Steriflip filter unit, and determining the final BSA concentration by optical absorbance at 280 nm (molar extinction coefficient 4.62e04 per molar per cm). Each tubulin dilution and a control sample of BSA diluent alone (no tubulin) was added (22 uL) to separate sample wells and allowed to adsorb for 1 hr at room temperature sealed in a petri dish at 100% relative humidity. The wells were rinsed with four 50-uL aliquots of water, filled with 22 uL of Odyssey Blocking Buffer (#927-4000, LI-COR), incubated 2 hr at room temperature, rinsed with four 50-uL aliquots of water, and filled with water until use (same day).

c) Probe Labeling

Anti-beta-tubulin monoclonal antibody (# 05-661, without primary amine additives such as the preservative sodium azide, Cytoskeleton Inc) was labeled with the amine-reactive fluorescent dye 680LT-NHS using a reagent kit (#928-38070, LI-COR). The antibody (100 ug) was dissolved in 100 uL of PBS, and the solution was adjusted to pH 8.5 using 1M K2HPO4 pH 9 with pH dye indicator strips. The protein solution was warmed to 20-25 C, mixed with 0.7 uL of dye solution (3.6e-03 M in water) gently by inverting the tube, and the reaction was allowed to proceed in the dark at 20 C. The reactant amounts were 6.25e-10 moles of antibody and 2.5e-09 moles of dye. The antibody was separated from free dye using a kit-provided Zeba Desalting Spin Column (Pierce). The purified antibody was quantified by measuring optical absorbance at 280 and 680 nm as described in the kit instructions (molar extinction coefficients for protein E280=2.03e05 and E680=0; for dye E280=2.50e05 and E680=2.50e04). The purified antibody was obtained in a final volume of 100 uL, concentration 5.3e-06 M, dye to protein ratio 1.75. The labeled antibody was diluted to 1e-10 M in diluent solution (1e-05 M BSA, 0.1% Igepal surfactant) and stored on ice in the dark for up to 6 hr prior to use (Probe Binding Reaction, below).

d) Instrument Setup

A 680 nm laser diode was coupled into a multi-mode 50 um optical fiber. The laser beam was passed through a band-pass filter (680DF15) and a mechanical shutter (SmartShutter with Lambda SC control unit, Sutter Instruments), before being focussed into the fiber end. The fiber, delivering 27 mW of optical power at the output end, was coupled to an Olympus TIRF illuminator mounted on an Olympus IX-70 inverted microscope. The beam was reflected by a dichroic filter (Q690LP) and directed to the imaging plane by an objective lens (Olympus PlanApo 60x/1.45 oil TIRFM infinity/0.17). In non-TIRF mode (angle of incidence 0 degrees), 3.5 mW of optical power was delivered to the imaging plane. In TIRF mode (angle of incidence 68 degrees), the beam was reflected by TIR at the glass-water interface back into the objective lens. The TIR reflected beam was blocked by a small black screen located near the back focal plane of the objective lens. Fluorescence captured by the objective lens was focussed by the tube lens of the microscope into an electron-multiplying CCD camera (Cascade 512B, Roper Scientific). The camera was controlled by a custom MATLAB program utilizing MATPVCAM routines (http://www.eng.utoledo.edu/˜smolitor/download.htm) and PVCAM driver software (Roper Scientific). The mechanical shutter was controlled by the same custom MATLAB program by serial I/O.

e) Probe Binding Reaction

The coverglass surface of the sample well was brought into focus by observing the sparsely distributed Qdot nanocrystals applied earlier (see Protein Immobilization). Water in the well was replaced by 20 uL of the 1e-10 M antibody probe solution (see Probe Labeling) to initiate the reaction (time zero), and the well was sealed by a drop of mineral oil to prevent evaporation. Data were acquired for 10-15 minutes in an automated cycle comprising: open the shutter, acquire an image (100-300 msec exposure), save the image to disk, continue illuminating the sample for 6 sec to bleach most of the bound probes, close the shutter, repeat with a period of 60 sec. Probes binding in the dark period (60 sec−6 sec=54 sec) are imaged in the subsequent exposure. Probes binding in the imaging and bleaching phase (6 sec) may go undetected in the subsequent image, but their existence can be corrected for given the bleaching probability in data analysis.

f) Binding Event Analysis

A custom MATLAB program was used for data analysis, based on published algorithms from S S Rogers et al (2007) “Precise particle tracking against a complicated background: polynomial fitting with Gaussian weight”, Physical Biology 4:220, and from http://personalpages.manchester.ac.uk/staff/salman.rogers/polyparticletracker/. In each image frame F(i), single fluorescent antibody molecules are identified as point spread functions (psf's) spanning an area of about 9 pixels (3×3). The peak intensity pixel of each gray-scale psf is recorded as a single pixel (not a psf) of maximum brightness (intensity 255) in an ‘accumulant’ image A(i) of otherwise black background (intensity 0) and of the same row-column dimension as images F(i). After all images F(i) have been analyzed, the corresponding stack of images A(i) are added cumulatively, and the number of particles (i.e. comprising one or more contiguous pixels) are counted in the time-series of images A(i).

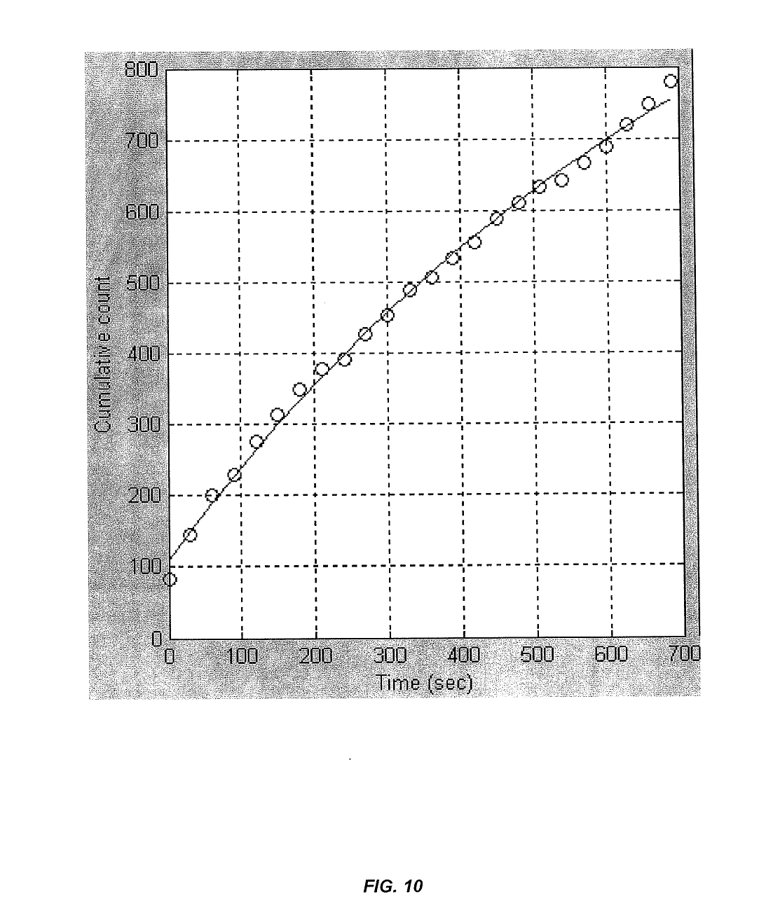

An example of the accumulating counts is shown in FIG. 10 (circles), of the well where proteins were adsorbed from a solution of 1.6e-09 M tubulin in 1e-04 M BSA (see Protein Immobilization). This analytical approach applies in instances of low surface densities of tubulin proteins dispersed at optically-resolved distances, as in the present example. However, the Rogers' particle-finding algorithms (and other published algorithms) by default provide sub-pixel x-y locations of the psf centers. Thus, at higher surface densities, the super-resolved centers of each gray-scale psf should be mapped to higher-resolution images A(i), where each pixel now represents a smaller physical area than in the relatively low-resolution acquired images F(i).

g) Binding Kinetics

The accumulating counts of binding events (FIG. 10, circles) were fit to a kinetic model of probes binding to targets. In this example, it was assumed that the antibody probe has high affinity for the tubulin target, that the rate of unbinding between probe and target is low relative to the rate of binding, and that any unbinding/rebinding events would overlap in the pixel space of the accumulating images A(i) and thus would be counted only once as an individual target. The kinetic model is

p(t)=tot*(1−exp(−k*t))

where p is the number of targets per unit area binding a probe by elapsed time t, k is the binding constant, and tot is the total number of tublin targets per unit area. The model was fit to the data by non-linear least-squares optimization (FIG. 10, line), yielding a total tubulin count of 65,000 per square millimeter for the sample well described above in Binding Event Analysis.

h) Assay Linearity

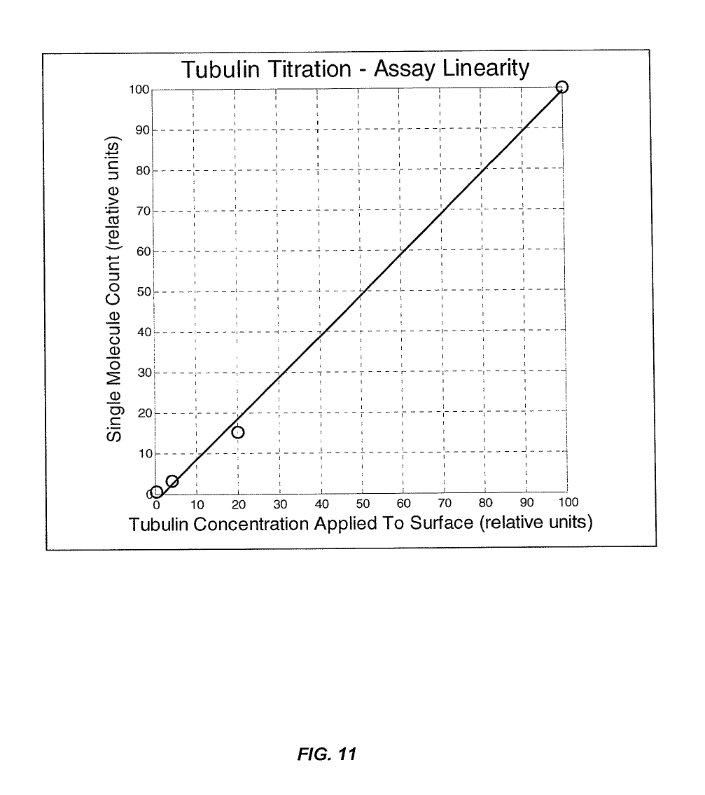

All five sample wells were analyzed as described (see Binding Kinetics). Background binding of the probe in the control well without tubulin was 2.6% that of the well with the most tubulin. After subtracting this background from the measured tubulin counts in each sample well, and plotting the results scaled to 100 relative to the well with the most tubulin, we see a linear response to increased tubulin amounts (line slope=1.01, y-intercept=−1.6) (FIG. 11).

i) Whereas the present example analyzes binding kinetics in a simple model for a high-affinity probes, elaborated models incorporating both binding and unbinding would be required for lower-affinity probes, as well as for measuring repeated bind/unbind events at the same immobilized target as described in the specification text.

### Example 7

### This Example Shows the Binding of Probes to EGFR

A lysate or protein preparation from A431 cells which overexpress the epidermal growth factor receptor (EGFR) is attached to a solid support in a microplate-like device or microfluidic device with an observation chamber.

1. The sample is probed with:
a. An antibody for EGFR labeled with IRDye 680LT and a video of the interactions of this probe are recorded, analyzed and classified according to kₒₙ and/or k_{off}. The difference in rates distinguishes between specific and non-specific interactions of the probe.
i. A secondary approach is to use an IRDye 680LT labeled secondary antibody or streptavidin to detect the EGFR primary antibody.
b. In a subsequent probing use the phospho-EGFR Tyr1045 antibody (Rabbit; Cell Signaling Technology, 2237).
c. In a subsequent probing, use ERK rabbit antibody: Santa Cruz (Cat.# sc-94)
d. In a subsequent probing use pERK mouse antibody: Cell Signaling Technology (Cat.# 9106).
e. In a subsequent probing use the Rabbit Î±-phospho-Stat3 (CalBiochem 568389)
2. The sample is probed with a panel of probes whose binding properties identify EGFR with a binding signature for the probe set.
3. The sample is probed with:
a. IRDye 680-labeled EGF and a binding profile is generated.
b. IRDye 680-labeled heregulin and a binding profile is generated.
4. The sample is probed with:
a. IRDye 680-labeled Neuregulin 1 or NRG1 is a protein which in humans is encoded by the NRG1 gene. NRG1 is one of four proteins in the neuregulin family that act on the EGFR family of receptors.

### Example 8

### This Example Shows the Binding of Probes to an Array

A collection of purified proteins is used in a protein array or co-immunoprecipitation, for example, a segment of a genome or a pathway which attached to a solid support in a microplate-like device or microfluidic device with an observation chamber.

1. The sample is probed with a labeled protein whose binding partners are unknown:
a. A IRDye 680LT labeled protein and the binding signatures for each protein type are recorded. The identity of each protein type is determined with probe signatures as above.

All publications and patent applications cited in this specification are herein incorporated by reference as if each individual publication or patent application were specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

1. A method for characterizing at least one protein in a plurality of proteins, said method comprising:
contacting said plurality of proteins with a panel of probes, wherein at least one probe has a unique label, to generate a transient binding interaction of at least one probe of said panel of probes with at least one protein of said plurality of proteins; and
detecting said transient binding interaction by single molecule detection of said unique label to generate a time spectrum, wherein said time spectrum characterizes said at least one protein.

2. The method of claim 1, wherein said at least one protein of said plurality of proteins is immobilized.

3. The method of claim 2, wherein said plurality of proteins are randomly immobilized.

4. The method of claim 3, wherein said plurality of proteins are immobilized on a surface selected from the group consisting of glass, quartz, and plastic.

5. The method of claim 3, wherein said plurality of proteins are immobilized on a surface using a member selected from the group consisting of a hydrophilic self-assembled monolayer approach, a hydrophilic polymer brush approach, a zwiterionic polymer brush approach and a nitrile coating approach.

6. The method of claim 3, wherein said plurality of proteins are randomly immobilized at a surface density of about 2 proteins to about 1.0×10⁶ proteins per 100 μm×100 μm.

7. The method of claim 6, wherein said plurality of proteins are randomly immobilized at a surface density of about 2.0×10² proteins to about 8.0×10⁵ proteins per 100 μm×100 μm.

8. The method of claim 6, wherein said plurality of proteins are randomly immobilized at a surface density of about 2.0×10³ proteins to about 6.0×10⁴ proteins per 100 μm×100 μm.

9. The method of claim 6, wherein said plurality of proteins are randomly immobilized at a surface density of about 2.0×10³ proteins to about 1.0×10⁴ proteins per 100 μm×100 μm.

10. The method of claim 1, wherein said method further comprises one or more members of group consisting of distinguishing, counting, quantifying, and identifying said at least one protein.

11. The method of claim 1, wherein detecting of said transient binding interaction for said at least one probe is accomplished using a member selected from the group consisting of a total internal reflection fluorescence (TIRF) microscope, FRET, multi-photon, polarization, plasmonic effects, atomic force spectroscopy, fluorescence lifetime, light scattering, and Raman scattering.

12. The method of claim 11, wherein detecting of said transient binding interaction for said at least one probe is accomplished using a total internal reflection fluorescence (TIRF) microscope.

13. The method of claim 12, wherein single molecule detection has spatial resolution at about 1 nm to about 100 nm.

14. The method of claim 12, wherein single molecule detection has spatial resolution at about 5 nm to about 50 nm.

15. The method of claim 12, wherein single molecule detection has spatial resolution at about 10 nm to about 40 nm.

16. The method of claim 1, wherein said time spectrum is an integrated affinity of said at least one probe for said at least one protein of said plurality of proteins.

17. The method of claim 1, wherein said transient binding interaction of at least one probe with at least one protein is a plurality of transient binding interactions of said panel of probes with said at least one protein.

18. The method of claim 1, further comprising correlating said time spectrum with a library of time spectra to characterize said at least one protein.

19. The method of claim 1, wherein said at least one probe of said panel of probes is a peptide.

20. The method of claim 1, wherein said at least one probe of said panel of probes is a small molecule.

21. The method of claim 1, wherein said at least one probe of said panel of probes is an aptamer.

22. The method of claim 1, wherein said at least one probe of said panel of probes is member selected from the group consisting of an antibody, an affibody and a nanobody.

23. The method of claim 1, wherein the number of probe types in the panel of probes is less than the number of protein types in said plurality of proteins.

24. The method of claim 1, wherein said transient binding interaction of said at least one probe with to said at least one protein is categorized as a low affinity (O), medium affinity (1) or high affinity (2) and the number of probe types is (r) and the patterns of affinity is c^{r}.

25. The method of claim 24, wherein said at least one probe is a low-affinity and a low-specificity probe.

26. The method of claim 1, wherein said panel of probes is homogeneous.

27. The method of claim 1, wherein said panel of probes is heterogeneous.

28. The method of claim 1, wherein said transient binding interactions of at least two probe types of said panel of probes with said at least one protein is imaged simultaneously.

29. The method of claim 28, wherein said transient binding interactions of about 2 to about 15 probe types of said panel of probes are imaged simultaneously.

30. The method of claim 28, wherein said transient binding interactions of about 3 to about 10 probe types of said panel of probes are imaged simultaneously.

31. The method of claim 1, wherein the affinity of said transient binding interaction for said at least one probe of said panel of probes is measured via a competitive binding assay.

32. The method of claim 1, wherein said transient binding interaction is characterized by at least one constant selected from the group consisting of an association rate constant (kₒₙ), an dissociation rate constant (k_{off}) and a combination thereof.

33. The method of claim 32, wherein the summation of said at least one probe transient binding interactions is a time spectrum for said at least one protein.

34. The method of claim 1, wherein said time spectrum represents the integrated affinity of one probe for the target protein.

35. The method of claim 34, wherein at least two probe types from said panel of probes is used to generate a corresponding set of time spectra that together comprise a unique fingerprint of said at least one protein type in said plurality of proteins.

36. The method of claim 1, wherein the transient binding interaction for said at least one of probe is modulated by an electric field, a magnetic field, a convective flow, a temperature change, a pH change, an ionic strength change, and a combination thereof.

37. The method of claim 3, wherein said surface comprises an enclosure.

38. The method of claim 37, wherein said enclosure has an oxygen free atmosphere.

39. A method for measuring a transient binding interaction between at least one protein in a plurality of proteins with at least one probe of a panel of probes, said method comprising:
contacting a plurality of proteins immobilized on a support with a panel of probes, wherein at least one probe has a unique label, for a time sufficient to generate a transient binding interaction of at least one probe of said panel of probes with at least one protein of said plurality of proteins; and
measuring said transient binding interaction by single molecule detection of said unique label to generate a time spectrum, wherein said transient binding interaction is characterized by at least one constant selected from the group consisting of an association rate constant (kₒₙ), an dissociation rate constant (k_{off}) and a combination thereof.

40-79. (canceled)

80. A method for characterizing at least one biomolecule in a plurality of biomolecules, said method comprising:
contacting said plurality of biomolecules with a panel of probes, wherein at least one probe has a unique label, to generate a transient binding interaction of at least one probe of said panel of probes with at least one biomolecule of said plurality of biomolecules; and
detecting said transient binding interaction by single molecule detection of said unique label to generate a time spectrum, wherein said time spectrum characterizes said at least one biomolecule.

81-115. (canceled)


SEQUENCE LISTING (24 sequences)

SEQ ID NO: 1 - protein, 10 aa, Artificial Sequence
  synthetic naphthalo cyanine Atto647N dye labeled probe a1, Atto647N dye labeled Strep-tag I
SAWRHPQFGG

SEQ ID NO: 2 - protein, 10 aa, Artificial Sequence
  synthetic naphthalo cyanine Atto647N dye labeled probe a2, Atto647N dye labeled Strep-tag I
SAWRHPQFGG

SEQ ID NO: 3 - protein, 8 aa, Artificial Sequence
  synthetic naphthalo cyanine Atto647N dye labeled probe a3
SARHPQFG

SEQ ID NO: 4 - protein, 10 aa, Artificial Sequence
  synthetic naphthalo cyanine Atto647N dye labeled mutated probe a4
SAWRHPAFGG

SEQ ID NO: 5 - protein, 10 aa, Artificial Sequence
  synthetic naphthalo cyanine Atto647N dye labeled mutated probe a5
SAWRSPAFGG

SEQ ID NO: 6 - protein, 9 aa, Artificial Sequence
  synthetic naphthalo cyanine Atto647N dye labeled mutated probe a6
SAWDSPAFG

SEQ ID NO: 7 - protein, 11 aa, Artificial Sequence
  synthetic naphthalo cyanine Atto647N dye labeled probe a7
HWWWPASGGRR

SEQ ID NO: 8 - protein, 11 aa, Artificial Sequence
  synthetic naphthalo cyanine Atto647N dye labeled mutated probe a8
HRWWPASGGRR

SEQ ID NO: 9 - protein, 11 aa, Artificial Sequence
  synthetic naphthalo cyanine Atto647N dye labeled probe a9
HRWHPASGGRR

SEQ ID NO: 10 - protein, 11 aa, Artificial Sequence
  synthetic naphthalo cyanine Atto647N dye labeled mutated probe a10
HRWHPDSGGRR

SEQ ID NO: 11 - protein, 11 aa, Artificial Sequence
  synthetic naphthalo cyanine Atto647N dye labeled probe a11
VRIPVWHGGGS

SEQ ID NO: 12 - protein, 11 aa, Artificial Sequence
  synthetic naphthalo cyanine Atto647N dye labeled mutated probe a12
VEIPVSHGGGS

SEQ ID NO: 13 - protein, 10 aa, Artificial Sequence
  synthetic highly photostable silicon-phthalocyanine IRDye 700DX dye labeled probe x1, 700DX dye labeled Strep-tag I
SAWRHPQFGG

SEQ ID NO: 14 - protein, 10 aa, Artificial Sequence
  synthetic highly photostable silicon-phthalocyanine IRDye 700DX dye labeled probe x2, 700DX dye labeled Strep-tag I
SAWRHPQFGG

SEQ ID NO: 15 - protein, 8 aa, Artificial Sequence
  synthetic highly photostable silicon-phthalocyanine IRDye 700DX dye labeled probe x3
SARHPQFG

SEQ ID NO: 16 - protein, 10 aa, Artificial Sequence
  synthetic highly photostable silicon-phthalocyanine IRDye 700DX dye labeled mutated probe x4
SAWRHPAFGG

SEQ ID NO: 17 - protein, 10 aa, Artificial Sequence
  synthetic highly photostable silicon-phthalocyanine IRDye 700DX dye labeled mutated probe x5
SAWRSPAFGG

SEQ ID NO: 18 - protein, 9 aa, Artificial Sequence
  synthetic highly photostable silicon-phthalocyanine IRDye 700DX dye labeled mutated probe x6
SAWDSPAFG

SEQ ID NO: 19 - protein, 11 aa, Artificial Sequence
  synthetic highly photostable silicon-phthalocyanine IRDye 700DX dye labeled probe x7
HWWWPASGGRR

SEQ ID NO: 20 - protein, 11 aa, Artificial Sequence
  synthetic highly photostable silicon-phthalocyanine IRDye 700DX dye labeled mutated probe x8
HRWWPASGGRR

SEQ ID NO: 21 - protein, 11 aa, Artificial Sequence
  synthetic highly photostable silicon-phthalocyanine IRDye 700DX dye labeled mutated probe x9
HRWHPASGGRR

SEQ ID NO: 22 - protein, 11 aa, Artificial Sequence
  synthetic highly photostable silicon-phthalocyanine IRDye 700DX dye labeled mutated probe x10
HRWHPDSGGRR

SEQ ID NO: 23 - protein, 11 aa, Artificial Sequence
  synthetic highly photostable silicon-phthalocyanine IRDye 700DX dye labeled probe x11
VRIPVWHGGGS

SEQ ID NO: 24 - protein, 11 aa, Artificial Sequence
  synthetic highly photostable silicon-phthalocyanine IRDye 700DX dye labeled probe x12
VEIPVSHGGGS